(19) United States
(12) Patent Application Publication
(10) Pub. No.: US 2018/0060823 A1
(43) Pub. Date: Mar. 1, 2018

(54) INTEGRATED JOB BOARD FOR AUTOMATED HIRING AND TRACKING OF JOB APPLICATIONS

(71) Applicant: OnBlick Inc, Irving, TX (US)

(72) Inventors: Krishna K. GARIMELLA, Irving, TX (US); Shravan KORE, Hyderabad (IN); Srikanth BOUNDUGULAPATI, Hyderabad (IN)

(21) Appl. No.: 15/692,936

(22) Filed: Aug. 31, 2017

Related U.S. Application Data
(60) Provisional application No. 62/381,575, filed on Aug. 31, 2016.

(51) Int. Cl. G06Q 10/10; H04L 29/08

(52) U.S. Cl. CPC G06Q 10/1053; H04L 67/22; H04L 67/306

(57) ABSTRACT

A method for providing integrated job board for job management, the method comprising creating job requirements for users, wherein user comprises at least one of a recruiter of a company or an account manager or an administrator; posting the job requirements; receiving profiles from job seekers; matching job seekers profiles with the job requirements; listing one or more job requirements to the job seekers with a corresponding percentage compatibility, wherein the percentage compatibility is generated based on a plurality of parameters; listing one or more job seekers to the users with the corresponding percentage compatibility, wherein the percentage compatibility is generated based on the plurality of parameters; providing an integrated calling and chatting feature in the job board thereby allowing job seekers and users to connect instantly; tracking activities of the job seekers and the users; and providing updates to the job seekers and the users based on the tracking.

### TECHNICAL FIELD

Embodiments of the disclosure relate generally to job boards and applicant tracking systems (ATS). Embodiments relate more particularly to provide a method and system for an integrated job board for automated hiring and tracking of job seekers and activity around an application for Job.

### BACKGROUND

Job hunting (also known as job seeking or job searching) is the act of looking for employment due to several reasons. For instance, job seekers may be unhappy with a current position or would desire for a better position. Currently, a job seeker performs a manual search for job vacancies or opportunities on multiple job boards, and as a result a list of jobs is shown. However, the list may include a lot of irrelevant jobs to the skill sets of the job seeker. Job seekers are therefore left with no other choice, but to spend a considerable amount of time to identify relevant jobs from the list and then apply.

Upon applying, the job seekers are unaware of the status and normally do not have quick responses to their follow-ups. This leaves the job seekers skeptical about what might happen. In other words, tracking activities after applying for the Job is not available as it is at the discretion of the recruiter to respond back if interested in the profile. Further, job seekers are often unaware of market's demand and supply in his/her technical/functional domain.

Companies that offer jobs are also bound with several factors. For instance, companies are bound to use several systems to post jobs, track applications and maintain a database of applied candidates. The systems operate with manual entry, which is often prone to inconsistencies and unavoidable duplication. Consequently, job seekers may receive multiple calls from various recruiters of the same company thereby leaving the job seekers displeased.

Further, companies end up spending money, time and effort in the entire process of recruitment. For instance, companies spend a lot of money and time on various Vendor Management Systems (VMS) other than job boards.

Another pitfall that companies face is the limited visibility towards good customers/vendors and the work done by their recruiters or account managers. As a result, management or leadership is not given enough visibility to empower and motivate them in the right direction. The companies also take a long time to identify a good performer due to the lack of an automated tracking system.

Hiring/recruitment may become a tedious job to recruiters and account executives as well. Typically, the recruiters and account executives are non-technical and spend a considerable amount of time to match keywords of the requirement with resumes. Further, due to the lack of an automated process to keep track of their work, recruiters and account executives get limited recognition. They are often criticized by job seekers for being disorganized and not getting back on their applications due to lack of an automated process. Recruiters/Account Managers get hundreds of emails everyday making it difficult for them to keep a track of every applicant. Job seekers are also criticized by the recruiters for not responding or getting back on time for their job opportunities. It is very difficult for a passive job seeker (currently on a job) to be highly responsive to recruiters as it interrupts the current job of the job seeker. Moreover, job seekers lose track of their missed calls as bunch of calls are received in a day. Also, the phone numbers associated with the missed calls may be unknown to the job seeker, unless already stored, thereby making it difficult for the job seeker to prioritize whom to call and whom to not.

Currently, there are several solutions for the problems listed above. For instance, job boards, applicant tracking systems and recruitment tracking systems are available. However, job boards do not address the problem of tracking the activities. Further, the applicant tracking systems and recruitment tracking systems look to only address the issues for companies without any respite to job seekers. Moreover, applicant tracking systems depend on manual data entry by recruiters and account managers and are usually inconsistent due to these manual entry dependencies.

In light of the above discussion, there exists a need for an integrated job board and applicant/activity tracking system for automated hiring and tracking of job seekers and recruitment process.

### SUMMARY

The principal objective of the embodiments herein is to integrate a job board, activity tracking system, professional networking, artificial intelligence (GeekBot, Virtual assistant for Job seekers), Compliance and all communication tools into a single application thereby making hiring and tracking process completely automated also making sure the companies are compliant in this process.

Another objective of the embodiments herein is to provide critical metrics from activity data giving companies an opportunity to fine-tune their process and take proper decisions for the growth of the company.

Yet another objective of the embodiments herein is to give job seekers the market and technology analysis based on supply and demand of overall market and any particular technology of interests of the job seekers. This helps the job seekers update their skills accordingly and be prepared for the changing market and technology trends.

The above-mentioned needs are met by a method for providing integrated job board for job management. The method includes creating job requirements for users, where the user may be at least one of a recruiter of a company or an account manager or an administrator. The method further includes posting the job requirements, receiving profiles from job seekers, matching job seekers profiles with the job requirements, and listing one or more job requirements to the job seekers with a corresponding percentage compatibility. The percentage compatibility is generated based on a plurality of parameters. The method further includes listing one or more job seekers to the users with the corresponding percentage compatibility, where the percentage compatibility is generated based on the plurality of parameters. Furthermore, the method includes providing an integrated calling and chatting feature in the job board thereby allowing job seekers and users to connect instantly. Thereafter, the method includes tracking activities of the job seekers and the users, and providing updates to the job seekers and the users based on the tracking.

One another major mention about Organization Compliance, is achieved through the well-defined processes, throughout employee employment, work authorizations, extensions and amendments.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of the environment related to at least some embodiments as disclosed herein;

FIG. 2 is a block diagram illustrating high level architecture, according to the embodiments as disclosed herein;

FIG. 3 is a flow chart describing a method for providing an integrated job board for automated hiring and tracking of job seekers, according to the embodiments as disclosed herein;

FIG. 4A-FIG. 4F are exemplary screenshots of the Sign up & Login process of job seekers/recruiters/account manager/management, according to the embodiments as disclosed herein;

FIG. 5A-FIG. 5D are exemplary screenshots of unique features of the method described herein, according to the embodiments as disclosed herein;

FIG. 6 is a block diagram of a machine in the example form of a computer system within which instructions for causing the machine to perform any one or more of the methodologies discussed herein may be executed;

FIG. 7A-FIG. 7C show my jobs section to seek application status for the job seeker, according to the embodiments as disclosed herein;

FIG. 8 shows advanced search options available to the job seeker, according to the embodiments as disclosed herein;

FIG. 9A-FIG. 9C show compatibility score and indicators that lack in a job seeker, according to the embodiments as disclosed herein;

FIG. 10A-FIG. 10B show activity tracking system of a job seeker, according to the embodiments as disclosed herein;

FIG. 11A-FIG. 11D illustrate how job seeker can set his preferences of availability to take or return calls, according to the embodiments as disclosed herein;

FIG. 12 illustrate options to do a generic search and to find other relevant job seeker profiles by a recruiter, according to the embodiments as disclosed herein;

FIG. 13 illustrates compatibility metric, according to the embodiments as disclosed herein;

FIG. 14 shows view of a job seeker profile that a recruiter gets to see, according to the embodiments as disclosed herein;

FIG. 15A shows the recruiter view for the job seeker profile and FIG. 15B shows the interface using which the recruiter can rate the job seeker, according to the embodiments as disclosed herein;

FIG. 16 shows matching profiles to the recruiter, according to the embodiments as disclosed herein;

FIG. 17 show the requirements split up by category as seen by the recruiter, according to the embodiments as disclosed herein;

FIG. 18 shows interface providing advanced search provisions to account manager, according to the embodiments as disclosed herein;

FIG. 19 shows interface for referring an internal candidate for the job by account manager (AM), according to the embodiments as disclosed herein;

FIG. 20 shows submissions by the AM, according to the embodiments as disclosed herein;

FIG. 21 shows interface for my submission of account manager, according to the embodiments as disclosed herein;

FIG. 22 shows a map interface for searching using zip code, according to the embodiments as disclosed herein;

FIG. 23 shows a dashboard for an administrator, according to the embodiments as disclosed herein;

FIG. 24 shows a set goal feature, according to the embodiments as disclosed herein;

FIG. 25 shows contact manager, according to the embodiments as disclosed herein;

FIG. 26 illustrates a method for creating a requirement, according to the embodiments as disclosed herein;

FIG. 27 illustrates a method for posting a requirement, according to the embodiments as disclosed herein;

FIG. 28 illustrates a method for unposting a requirement, according to the embodiments as disclosed herein;

FIG. 29 illustrates a method for sharing a job through job, according to the embodiments as disclosed herein;

FIG. 30 illustrates a method for sharing a job through candidates, according to the embodiments as disclosed herein;

FIG. 31 illustrates a method allowing W2, according to the embodiments as disclosed herein;

FIG. 32 illustrates a method allowing third party to participate in job management, according to the embodiments as disclosed herein;

FIGS. 33A and 33B illustrate a method for applying for job, according to the embodiments as disclosed herein;

FIG. 34 illustrates another method for applying for job, according to the embodiments as disclosed herein;

FIG. 35 illustrates a method for candidate rejection, according to the embodiments as disclosed herein;

FIG. 36 illustrates another method for candidate rejection, according to the embodiments as disclosed herein;

FIG. 37 illustrates a method for pay validation, according to the embodiments as disclosed herein;

FIG. 38 illustrates a method for bulk upload, according to the embodiments as disclosed herein;

FIG. 39 illustrates a method for bulk mailing, according to the embodiments as disclosed herein;

FIG. 40 is a method for job management using a job board, according to the embodiments as disclosed herein;

FIG. 41 is a method for job management by a job seeker using a job board, according to the embodiments as disclosed herein;

FIG. 42 is a method for job management by a user using a job board, according to the embodiments as disclosed herein;

FIG. 43 (FIGS. 43A and 43B) illustrates a method for job management along with on boarding compliance, according to the embodiments as disclosed herein;

FIG. 44 (FIG. 44A and FIG. 44B) illustrates H1B process, according to the embodiments as disclosed herein;

FIG. 45 (FIG. 45A, FIG. 45B and FIG. 45C) illustrates OnBoarding process, according to the embodiments as disclosed herein;

FIG. 46 illustrates LCA ((Labor condition application) process, according to the embodiments as disclosed herein;

FIG. 47 illustrates contracting process, according to the embodiments as disclosed herein;

FIG. 48 (FIG. 48A and FIG. 48B) illustrates OPT (Optional Practical Training) and CPT (Curricular Practical Training) process, according to the embodiments as disclosed herein; and

FIG. 49 illustrates process of Green Card (GC) or PERM, according to the embodiments as disclosed herein.

### DETAILED DESCRIPTION OF THE EMBODIMENTS

The above-mentioned needs are met by a computer-implemented method and system to provide an integrated job board for automated hiring and tracking of job applications. The following detailed description is intended to provide example implementations to one of ordinary skill in the art, and is not intended to limit the invention to the explicit disclosure, as one or ordinary skill in the art will understand that variations can be substituted that are within the scope of the invention as described.

Typically, a job board is either a physical or electronic location where job opportunities are posted. In other words, the job board is a website that allows employers posts jobs for a fee.

The method described herein is a digital job board that provides end to end recruitment solution. The job board provides a single application that enables job seekers and recruiters to identify, connect and process jobs and applications simultaneously.

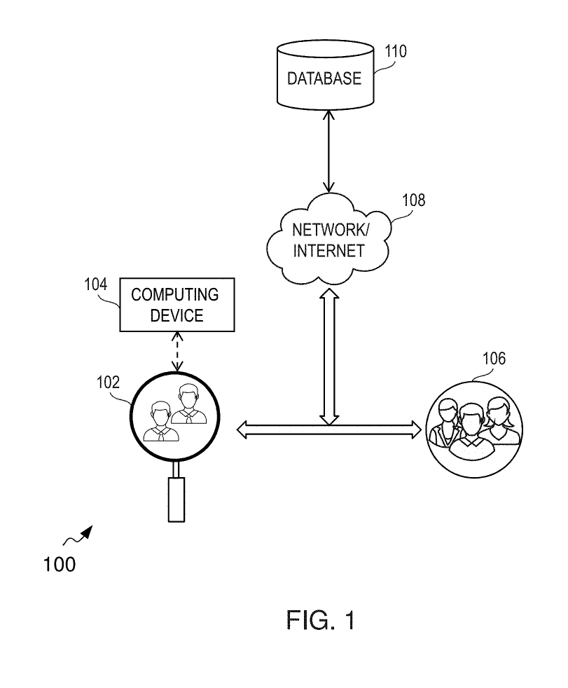

FIG. 1 is a block diagram of the environment, according to the embodiments as disclosed herein. The environment 100 includes one or more job seekers 102, a computing device 104, and a plurality of recruiters 106, a network 108 and a database 110.

The job seekers 102 are those people who are looking for a job (an activity performed in exchange of payment). Typically, a job is a regular activity performed in exchange for payment.

The computing device 104 is operated by the job seekers 102. The computing device 104 is a portable electronic or a desktop device configured with a user interface (not shown in FIG. 1) to interact with the job seekers/recruiters. Examples of the computing device 104 include, but are not limited to, a personal computer (PC), a mobile phone, a tablet device, a personal digital assistant (PDA), a smart phone and a laptop. Examples of the user interface include, but are not limited to, display screen, keyboard, mouse, light pen, appearance of a desktop, illuminated characters and help messages.

The computing device 104 is configured with a non-transitory computer-readable medium (also referred to as an application), the contents of which causes to perform the method disclosed herein. Further, the application is functional both as a web application (including websites, portals, plugins etc.) and as a mobile application thereby giving an opportunity for job seekers and companies to be mobile.

The recruiters 106 basically work to fill job openings in businesses or organizations. A recruiter reviews job seekers experiences, negotiates salaries and places job seekers 102 in agreeable employment positions. There are various categories of recruiters, for instance, headhunters, executive recruiters, internal recruiters, Information Technology (IT) recruiters and so on. However, all the recruiters 106 search for qualified applicants for job and work to connect organizations with job seekers 102 for employment. Typically, the recruiters 106 create a list of the most qualified job seekers 102 and present the list to a hiring manager.

Further, the recruiters 106 also operate on computing devices (not shown in FIG. 1).

Network link(s) involved in the system of the present invention may include any suitable number or arrangement of interconnected networks including both wired and wireless networks. By way of example, a wireless communication network link over which mobile devices communicate may utilize a cellular-based communication infrastructure. The communication infrastructure includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link may further include, or alternately include, a variety of communication channels and networks such as WLAN/Wi-Fi, WiMAX, Wide Area Networks (WANs), and Blue-Tooth.

The database 110 stores all applied/viewed job seekers profiles automatically. This eliminates the hassle of downloading and again parsing into a different tracking system.

It should be appreciated by those of ordinary skill in the art that FIG. 1 depicts the computing device 104 in an oversimplified manner and a practical embodiment may include additional components and suitably configured processing logic to support known or conventional operating features that are not described in detail herein.

### High Level Architecture of Product

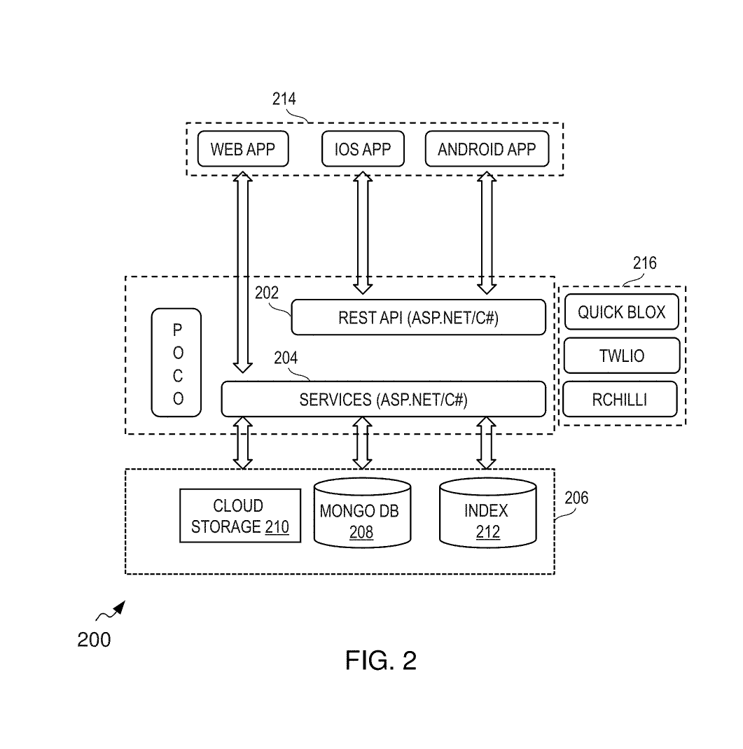

FIG. 2 is a block diagram of a system depicting the high level architecture. The system described in present disclosure is interchangeably referred to as “OnBlick system” or simply as “OnBlick”, and these should be considered merely names to describe various embodiments of the present disclosure. The OnBlick has been designed to be in a layered architecture, which is capable of scaling to handle higher volume requests. Its design is flexible to make each of the layer to be deployed into one or more different instances to extend the capacity at any given point.

A REST API 202 and a services layer 204 are where the primary business logic exists. This layer shares the POCO (Plain Old CLR Objects) for data transmission and communication between the functions. The Rest API 202 and the services layer 204 can access an application store 214 (e.g., see, Web App, IOS App, Android App).

Next layer is a data layer 206, where the data has been segregated into three different kinds of stores. A primary database, i.e. the MongoDB 208 has been setup with replica set, enabling it for quicker access and support failover or fallback mechanism. The second set of data is for quicker access using a Cloud REDIS storage 210. All frequently used data will be stored here for quicker access as it is in-memory data storage. A third type of data set is an index database 212 which is used to enable searching for the data from the application. The product 200 also uses one or more cloud communications platforms such as Quickblox, Twelio and RChili (as denoted by box 216) that provide one or more APIs that can be used for providing various features (for example, providing an integrated call and a chat feature on the job board) of the present invention.

### Operational Flow Chart

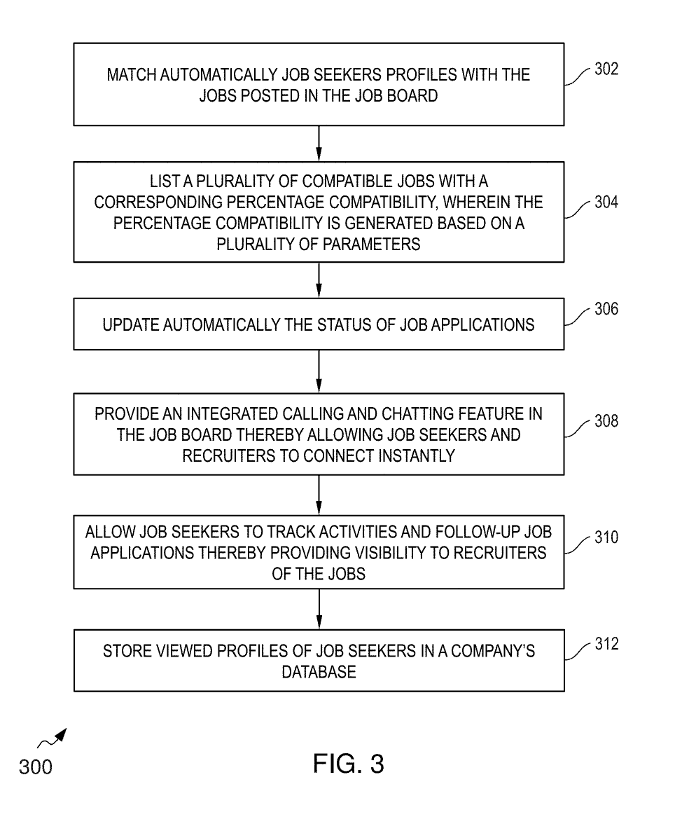

FIG. 3 is a flow chart describing a method 300 for providing an integrated job board for automated hiring and tracking of job seekers, according to the embodiments as disclosed herein. The method 300 begins at step 302.

As a perquisite, job seekers (such as the job seekers 102) upload their profiles and jobs are posted in the job board. Typically, the job board allows job seekers, recruiters, account executives and management to subscribe.

At step 302, job seekers profiles are matched automatically with the jobs posted in the job board.

The matching is performed with the aid of a “Compatibility view algorithm”. The matching results produced by the algorithm are accurate thereby enabling job seekers to get the right jobs and companies to find the right job seekers/candidates. For a given Job, adhering to the priorities defined while creating the job, the best matching job seekers are already shown to the recruiter, along with the percentage of compatibility with a particular job. It makes life of recruiter so easy that, without even searching, as soon as the recruiter creates a job, he will be able to see top job seekers who are best match for a given job.

At step 304, a plurality of compatible jobs with corresponding percentage compatibility is listed. The percentage compatibility is generated based on a plurality of parameters. Examples of the parameters include, but are not limited to, skill match, location, experience, number of projects, project longevity and ratings. The recruiter generating the job defines compatibility priority amongst the parameters. Consequently, a close to accurate match of job seekers to requirements is achieved. This saves significant amount of time and effort.

At step 306, the status of job applications are updated automatically whenever there is a process.

At step 308, an integrated calling and chatting feature is provided in the job board. This allows job seekers and recruiters to connect instantly.

The job seekers are given visibility to the name and picture of the recruiter who generated the requirement. This allows the job seekers to connect with the recruiter based on the recruiter's communication preferences. A unique communication algorithm shows the relevance of the call or chat or mail sessions that has been established.

As soon as the recruiter comes across a job seeker for a particular job on OnBlick system, his intention will be to contact that job seeker to see if he is interested in applying for that particular job. OnBlick system provides in-App communication through which the recruiter can initiate a call/chat with that job seekers right from that particular job context. The job seeker in the receiving end will be able to see the context of the job of why he is receiving the call/chat from a particular recruiter and thus have an option to attend that call or not. If the Job seeker misses this call/chat, he still has the notification along with the details of who tried reaching him, what is the purpose so that he wouldn't miss any important communication.

The calling and chatting feature carries relevance for the call or chat by displaying the job opportunity the recruiter is calling for and also by showing the percentage compatibility for that particular job. Such display is also made when the job seeker calls the recruiter associated to particular job.

At step 310, job seekers are allowed to track activities and follow-up job applications thereby providing visibility to recruiters of the jobs.

The tracking of all activities are performed by the Applicant Tracking System (ATS) which is integrated within the job board. The ATS reminds job seekers of follow-ups. Accountability is established between the job seekers and recruiters when communication is quick and track-able.

Every activity performed by different personas within the OnBlick system is captured as data point for future analytics. For example, in the recruitment process, typically an activity is started from the point of creation of job, then posting to different job boards, then viewing besting matching job seekers, then interacting with the potential job seekers, shortlisting, submitting to client, scheduling interview and finally hiring the job seekers. In this process, the OnBlick system automatically captures every activity performed by the recruiter, account manager and job seekers with respect to a particular job. Similarly, the activities related to job seeker, performing different job searches, viewing different kinds of jobs, applying for different jobs etc., interactions with the respective recruiters, are all tracked. Similarly, for the account manager, from the point of identifying the jobs for his company's bench talent, submissions to different jobs, scheduling of interviews etc., are all tracked.

Further, job seekers are allowed to perform a passive job search and filter while they are busy on a different assignment or task. Specifically, a unique feature of the method described herein is available to the job seekers. This feature is based on Artificial Intelligence (AI) and allows the job seeker to communicate with interested recruiters when he/she is busy.

Furthermore, precise metrics are generated to analyze performance of recruiters and account managers. The metrics (market metrics) signifies the demand and supply based on open jobs and competing job seekers with respect to technologies of the job seeker's interest.

At step 312, the viewed job profiles are stored in a company's database. The job profiles are automatically saved thereby eliminating the traditional manual entry of the recruitment process.

The viewed profiles and contacts of job seekers are stored in the application database along with respective timeline activity. This helps both parties to keep a track of previous interactions.

Further, all activities and communication are recorded under each job requirement. This eliminates duplication of activities and communications.

The method ends at step 312.

The method described herein is beneficial for several reasons as listed below:

1. It helps the recruiting and staffing industry to complete the recruiting cycle within one unique application.
2. The unique compatibility algorithm helps job seekers to find relevant opportunities and company's best fit resources.
3. It helps job seekers and company's communicate, track and analyze the activities in a single application/system.
4. It helps in passive search of jobs.
5. Market analytics provided herein aids job seekers and companies to make proper career and business decisions.
6. It helps to understand the utilization of company's resources.
7. It increases productivity and reduces overhead.

### Exemplary Screenshots

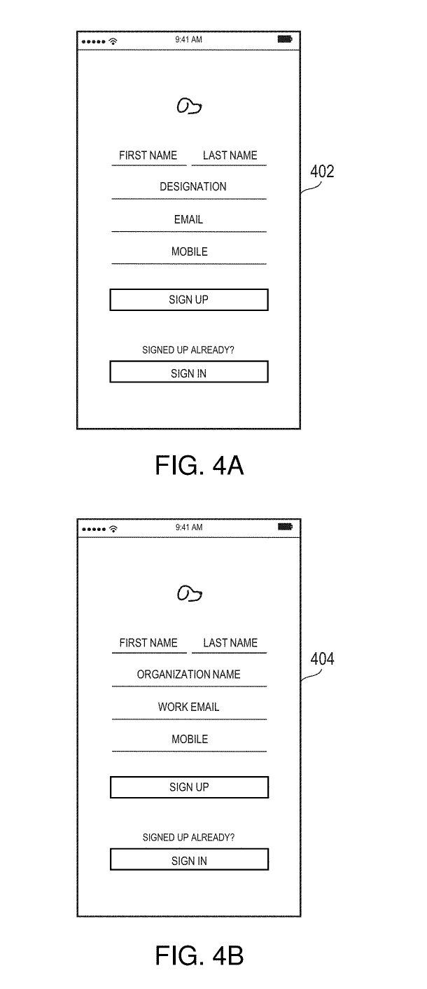

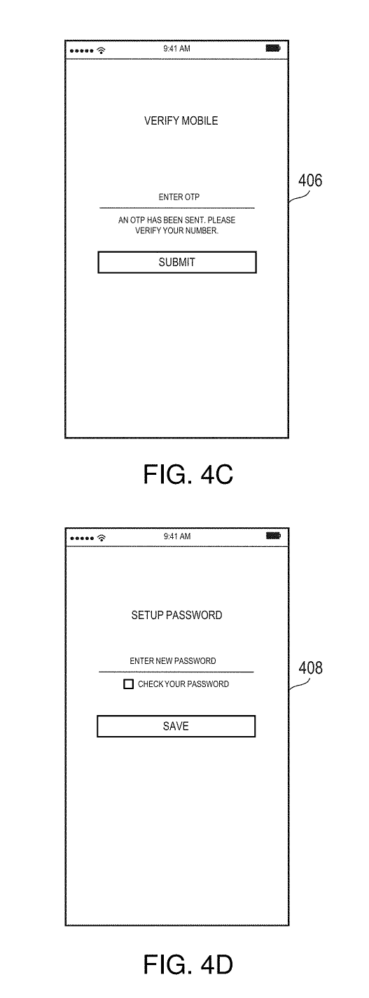

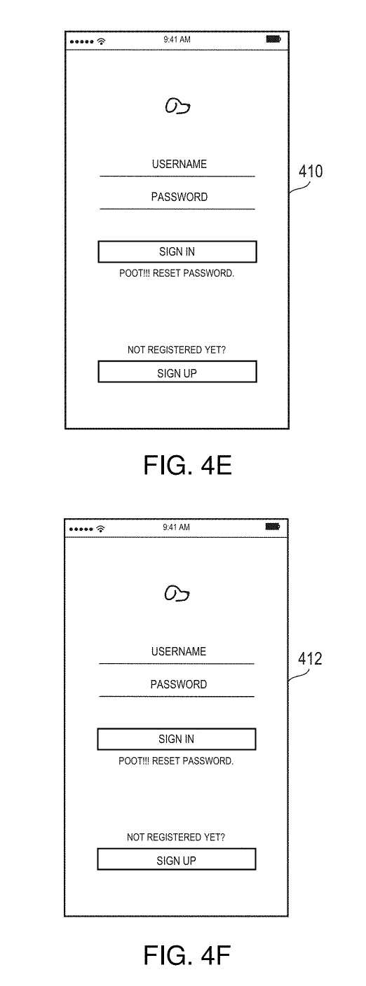

FIG. 4A-FIG. 4F are exemplary screenshots of the sign-up and sign-In process for a user (e.g., jobseeker, recruiter, account manager &management), according to the embodiments as disclosed herein.

FIG. 4A illustrates an exemplary job seeker's sign-up page 402. In some embodiments, after the job seeker signs in for first time, the job seeker chooses to create a profile and to validate resume. In an embodiment, the job seeker can choose to record a video profile of a pre-defined duration (for example 1 minute video profile) from the profile setup page. In an example, a 1 minute Video profile facilitated by the system helps recruiters to quickly analyze the job seekers communication skills, confidence, proactive approach etc., in turn helping the job seeker's chances of impressing recruiter.

The job seeker also gets to see a dashboard. The dashboard may include following sections:

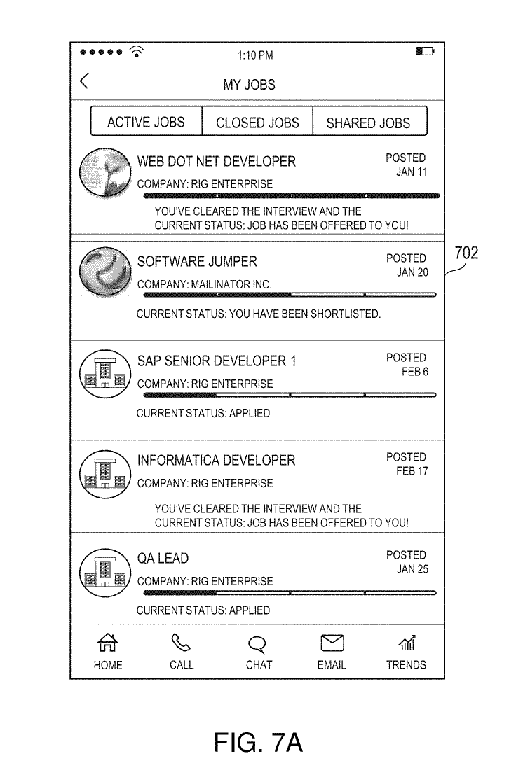

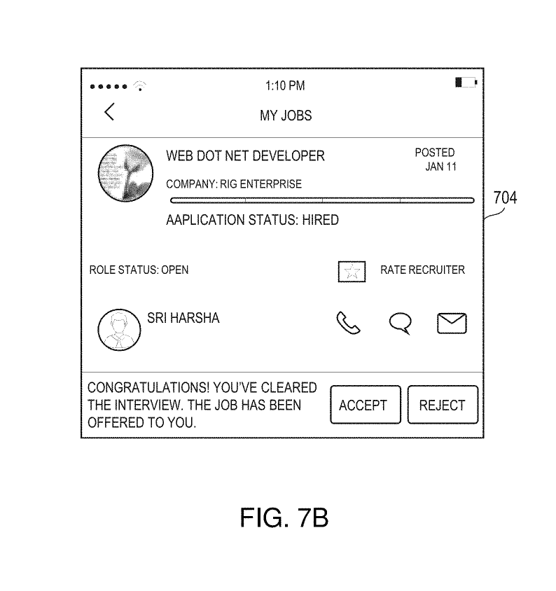

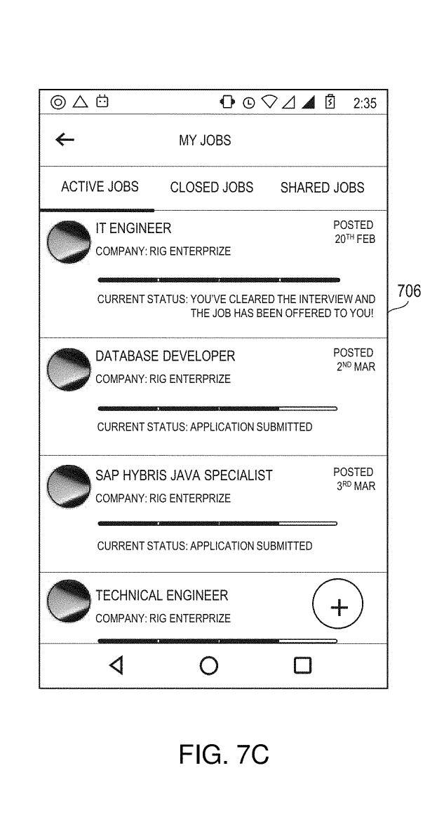

My Jobs: contain the jobs the job seeker have applied, closed and shared by other recruiters. Along with job information posting organization, the job seeker is able to see the application status such as active jobs, closed jobs and shared jobs from this section as shown in FIG. 7A by a system page 702, 7B by a system page 704, and 7C by a system page 706. It is understood that a system page is an example of a User Interface (UI) displayed on a display screen of the computing device associated with end user. System page may hereinafter alternatively be referred to as UI.

Matching Jobs: where the job seeker can see the trending/matching jobs in the market relative to skill set/designation. Also, the job seeker can get precise information related to the job postings. Job seeker can see all matching jobs automatically without even searching for the job. This happens basing on his skill sets from his profile. However, if the job seeker didn't setup profile, he will see trending Jobs.

User (here job seeker) is provided with updates related to the current market analysis of the trending skill sets. They have a visibility on their personal trends. This in turns help the user to update their technical skill sets and be ready for the market. Displays the jobs applied, short listed, submitted to client, interviewed, closed, hired and rejected jobs metrics so that job seeker keep track of these statistics and track.

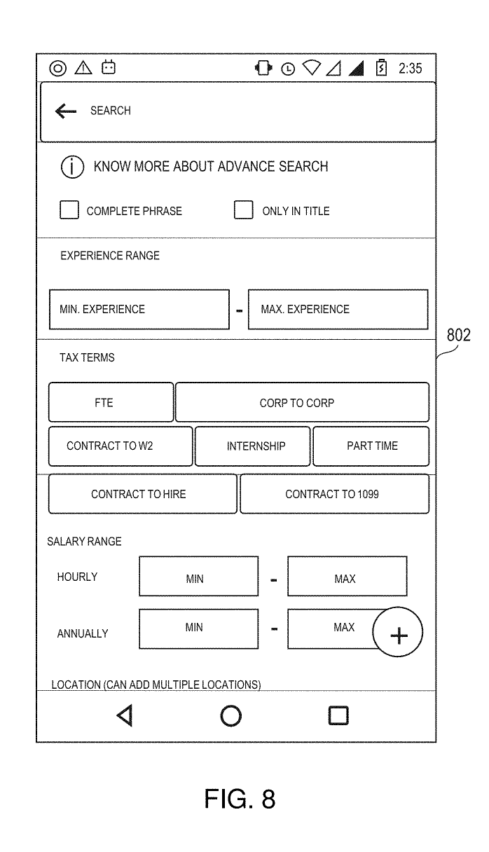

Search Jobs: Job seeker is provided with options to do a generic search and to find other relevant opportunities. Job seeker can search jobs and to find other relevant opportunities. He is provided with advanced search provisions as shown in FIG. 8 by a system page 802 where he can either select jobs nearby his location, matching or excluding the skills, matching his visa category etc. Job seeker has a search filter to opt for what type of role he is looking with an organization. Briefly the diversifications include:

### (a) Permanent/Full Time

### (b) Contract to Contract

### (c) Contract to W2

### (d) Contract to 1099

### (e) Contract to Hire

### (f) Intern

1099 Employee—A 1099 employee is in most cases a temporary employee (technically, not even an “employee”). Because they are not permanent, they do not need to complete a W-4 or have the employer withhold taxes. They are responsible for paying their taxes directly to the IRS. The IRS requires that the employer report the earnings paid on a form 1099. The IRS would rather put the burden of tax withholding on the employer and therefore has fairly stringent rules regarding when someone can be considered a 1099 employee.

Announced—Job Seekers that are ready to work in 30 days.

Corp-to-Corp—Indicates that the employer would prefer to deal directly with another corporation. The main reason for this preference is to avoid some of the potential liability that might exist in dealing with an independent contractor on a 1099 basis. This would include corporations dealing directly with other corporations or corporations dealing with individuals who have incorporated.

W-2—A W-2 employee is an employee whose taxes are withheld by the employer and whose earnings are reported to the IRS at the year-end via a W-2. The W-2 employee completes a form W-4 at the beginning of their employment to instruct the employer on how to withhold taxes. This eliminates any possible issues that may arise with the IRS regarding employment status.

W-2/1099—The position can be filled by either a W-2 or 1099 employee.

H-1B—Visa for temporary skilled workers (sponsored).

H-4—Visa for family members of H-1B Visa holder.

Independent—The employer is willing to hire a temporary employee on either a 1099 or W-2 Basis.

The IRS classifications of workers are independent contractors or employees according to the “common law” standard. The common law standard holds that if an employer controls and directs, or has the right to tell a worker how, when, and where to work, then the worker is an “employee”. A worker free from such direction and control can be classified as an “independent”.

Job Seeker—Candidate looking to better their employment opportunities.

Tax Term—Tax Terms include:

Full-time—Will be working as a full-time W-2 employee for the company.

Part-time—Will be working as a part-time W-2 employee for the company.

Contract—Corp-to-Corp—Will be working on contract with or through another corporation.

Contract—Independent—Will be working as a contract 1099 employee for the company.

Contract—W2—Will be working as a contract W-2 employee for the company.

Contract to Hire—Corp-to-Corp—Will be working on contract with or through another corporation with the option to hire.

Contract to Hire—Independent—Will be working as a contract 1099 employee for the company with the option to hire.

Contract to Hire—W2—Will be working as a contract W-2 employee for the company with the option to hire.

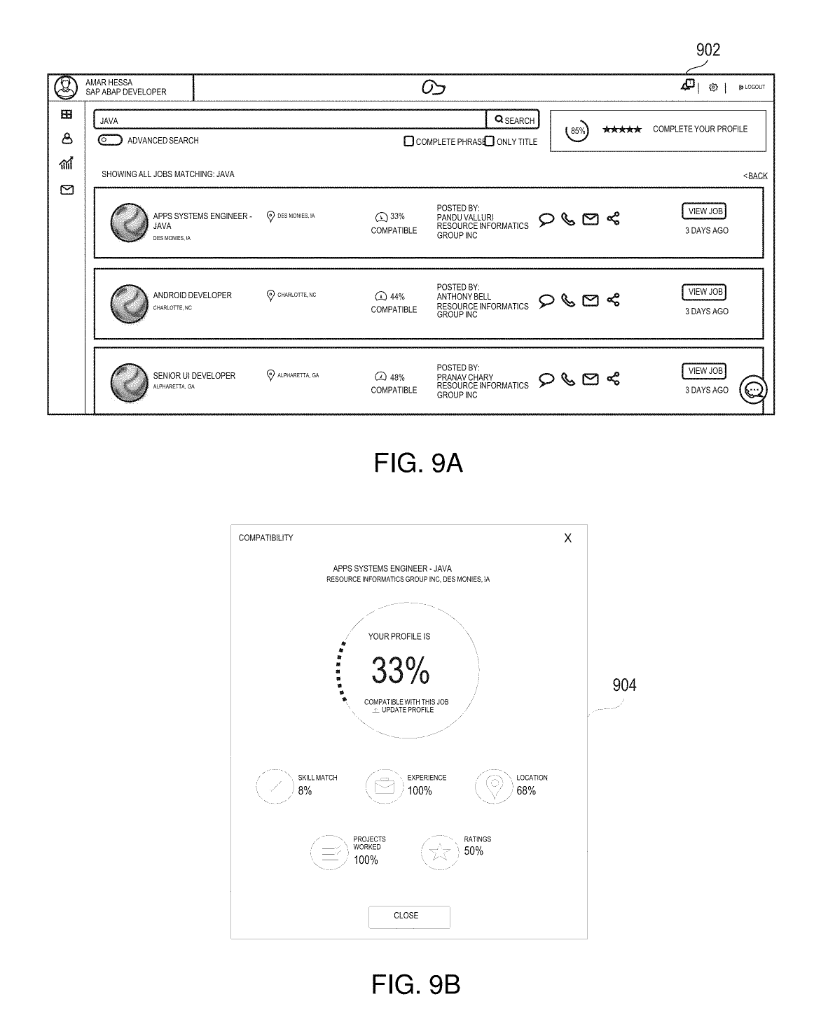

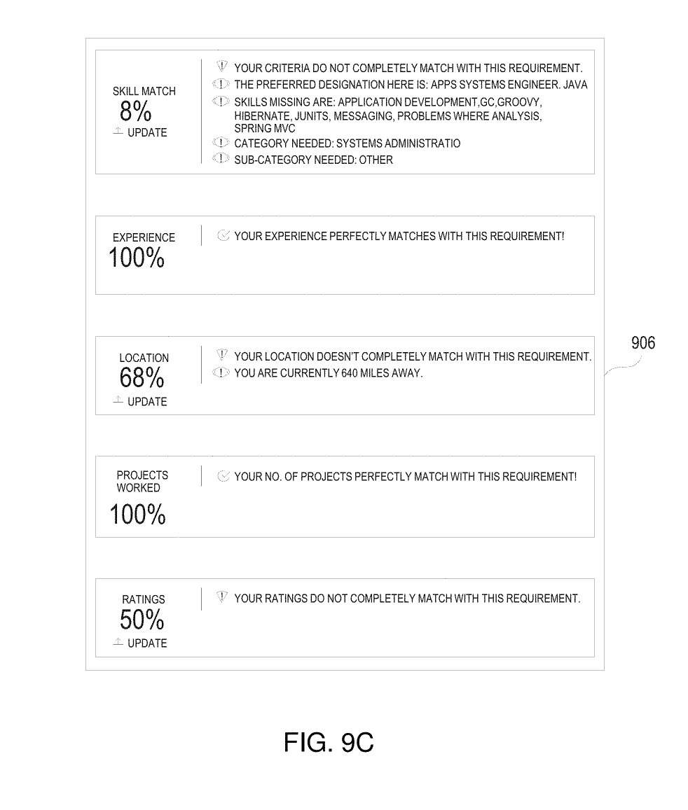

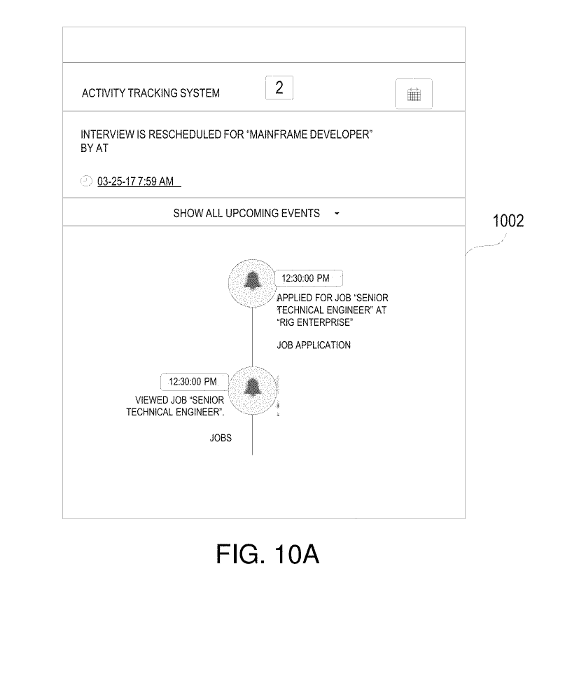

Job seeker can verify the compatibility of their profile versus the job required skill set as shown in FIG. 9A with a corresponding system page 902. All the search results show up with compatibility matching skills. Job seekers can also check what is missing in various parameters, which skills are missing, How much percentage of experience matches, their compatibility with the location, projects worked and ratings etc. as shown in FIG. 9B with a corresponding system page 904. As shown in FIG. 9C with a corresponding system page 906, if anything is missing with respect to the job, job seeker can go and update their profiles so that their compatibility score with this job might get improved which will improve the job seeker's chance to get selected after applying to this job will increase. OnBlick application provides the feature to view the jobs posted in different locations. User can search jobs by entering the zip code of the desired location. Application will display the available jobs with the brief information about the job. User can tap on desired job to view the complete details and can apply for the job.

If the job seeker wants to apply to the job, he/she can click view the job first and then apply. Job seeker can try to contact the recruiter if the recruiter enabled that option. Job seekers can chat/call/email with the recruiter who posted this job. They can even share this job to their friends who might be interested.

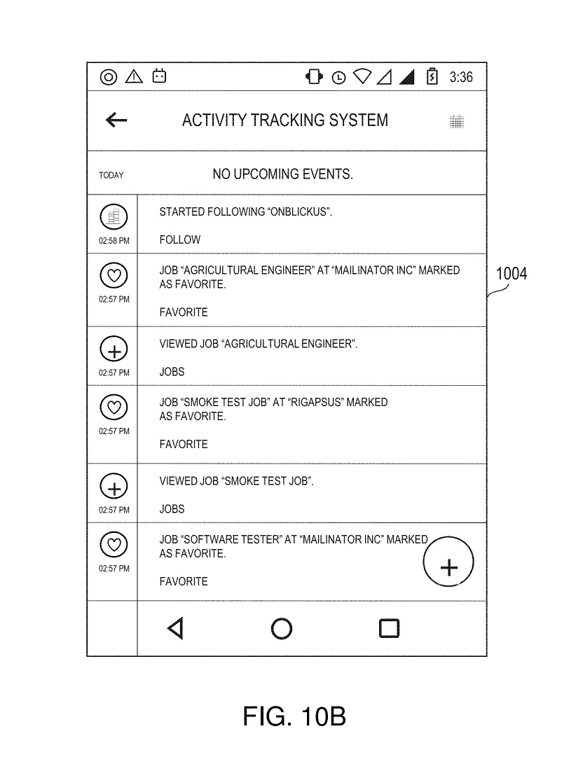

Activity Tracking system—Walkthrough of all the activities taken place in user profile as shown in FIGS. 10A and 10B with respective system pages 1002 and 1004. Activity manager captures all job seekers' activities and syncs every update and event within the application in a time-line format. It also sends timely reminders of appointments and deadlines.

Favorite jobs—Job seeker can mark a job as favorite for easy access to apply. Job seeker can favorite any jobs for further usage. This section displays those favorite jobs, the job seeker marked as favorite. He also has an option to filter the list from most recent to the old one and vice versa.

Profile tags—Whenever any recruiter views job seeker profile, job seeker gets to see that he is been viewed and can view which organization is interested in his profile. Whenever recruiter from an organization views a consultant profile, the organization gets tagged to the consultant, and that way he will be notified of the organization and view the jobs posted by that organization further.

User can see the list of all his profile views made by different recruiters in the profile tag screen. Also he can drill down to a particular view by tapping the corresponding cell in the list where he can see

(1) The entire job description of the job
(2) Options to communicate with the Recruiter/account manager who has posted the job
(3) Apply to that specific job
(4) Check his compatibility score etc.

Also, they can drill down to a particular view by tapping the corresponding cell in the list where they can see more details.

Following organizations—Job seeker can follow organization to keep updated with jobs organizations are posting not to miss any good opportunity. This contains list of all companies he is following as well as companies which he may like to follow. He can also search for a specific company that he likes to follow.

Contact Manager is the place which has detail list page where the user can find the list of all their contacts. Users also have an option to diversify their recruiter contact list with other contacts.

User can get in to the general settings page and can do the following settings such as

1. Turn on/off the GeekBot settings
2. Update the profile settings
3. Turning on/off the feed features to receive notifications
4. Turn on/off the profile visibility
5. Turn on/off the employer information
6. Also have an option to finally sign out from the application

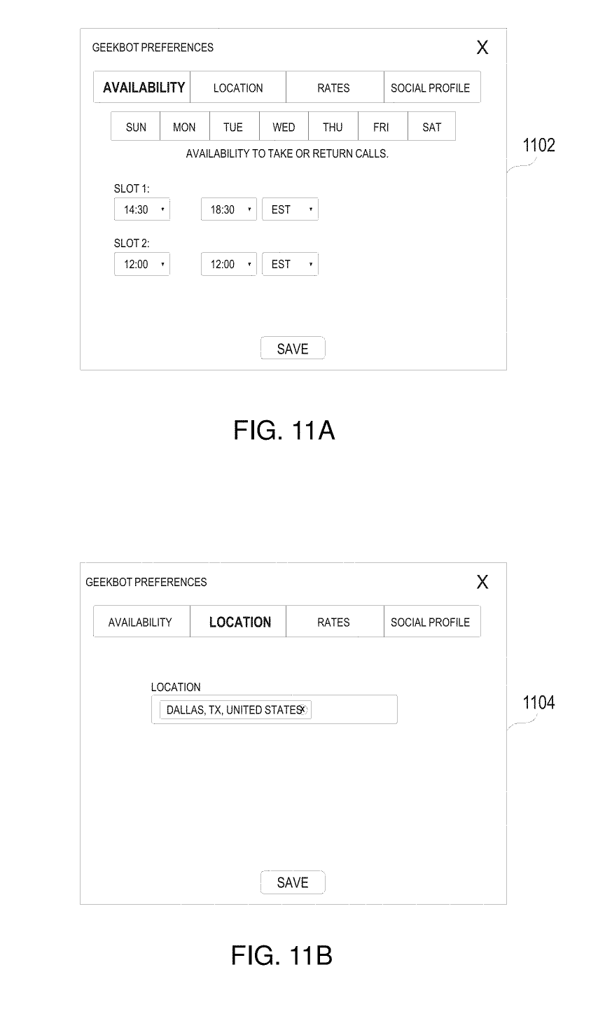

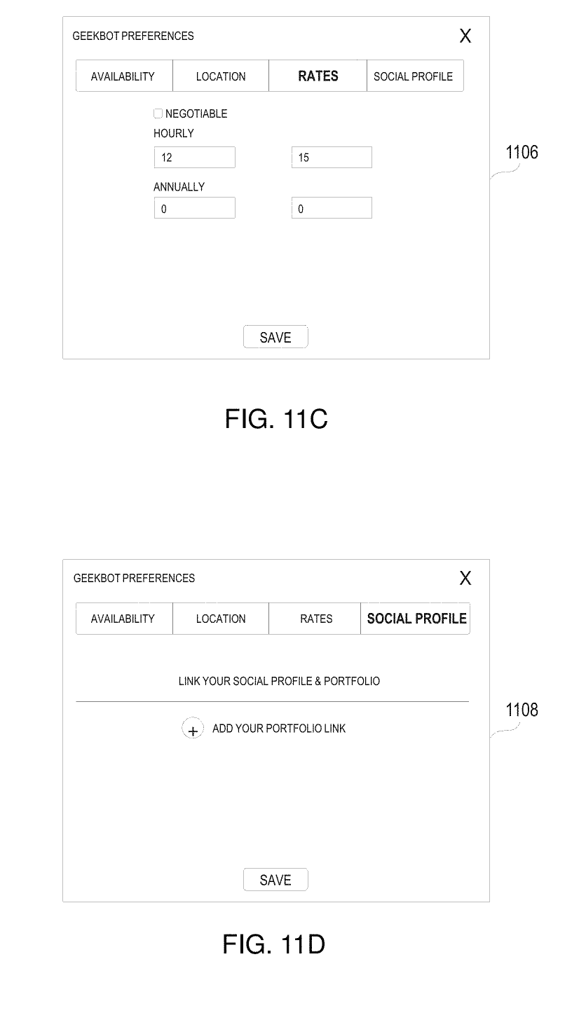

GeekBot Settings—Job seeker can set his preferences of availability to take or return calls as shown in FIGS. 11A-11D with corresponding system pages 1102 (for available timings), 1104 (for available location), 1106 (rates) and 1108 (for linking social profiles).

Whenever a Recruiter trying to reach out to a Job Seeker, for a specific requirement or additional information, if the Job Seeker is unable to attend the recruiter's call or Chat, the GeekBot will automatically take control and on behalf of Job Seeker it will respond back to the Recruiter to the information that is available. This will ensure that Job Seeker won't be missed with any important company trying to contact him and also recruiter will won't feel that the Job Seeker hasn't responded.

FIG. 4B illustrates an exemplary Recruiter's/account manager's/Management's/administrator's sign-up page 404. After a successful login in to application the recruiter will be landing into the page which is called recruiter dash board. Dash board contains various sections as described now.

Create a new requirement—One of the fundamental use-case for the recruiters is to create a requirement against which they will try to fulfill the profiles.

Requirements—Contains the jobs the recruiters have created, Opened, Closed and Auto Drafts. Recruiters can create a requirement in two ways such as by filling a form by giving the requirement details or by copying details from their email or file and then use those details to paste onto the clipboard to paste automatically. Recruiters can fill the Requirement creation form to put in the details they wanted to create the requirement.

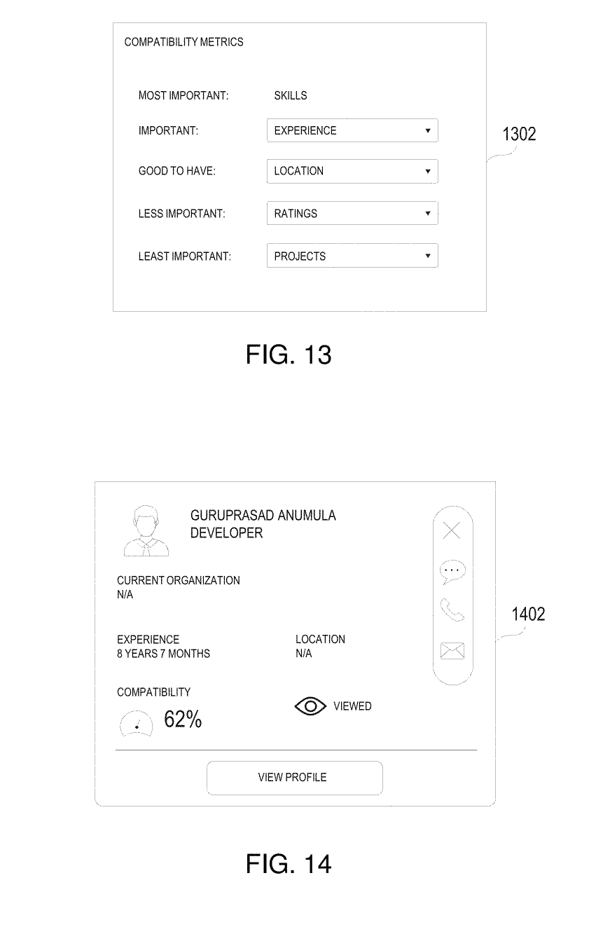

Recruiter may select one or more of the following details to create a requirement such as account manager, client details, end client details, open positions, start date, duration, job title, experience range, job location, tax terms allowed for this job, work permit required for this job, pay range, option to tell the job seekers that this job includes all expenses paid, option to tell the system that pay range needs to be hidden while viewing this job, job Description in HTML Format, key skills required for the requirement, technology category and sub category, minimum projects count required as eligibility to apply for this requirement option to select application repost preference—a. Allows vendors to submit only W2 candidates and b. Enables the vendors to submit external candidates as well, option to disable the Call/Chat facility for this requirement if the recruiter wants to do so and the like. Order of the Compatibility metrics are calculated as shown in FIG. 13 with a corresponding system page 1302. The OnBlick system assists the recruiter guiding with soc code details and suggestions of applied wages while creating jobs.

Once all the data is given and continue is clicked then recruiter can review all the details and post. Recruiter can edit the requirement if they wish to change the requirement details or they can click and create requirement to go ahead create the requirement. Recruiter can copy details from their email or file and then use those details to paste onto the clipboard to parse automatically. The OnBlick system assists the recruiters to do proper due diligence in recruitment process while hiring or rejecting.

The parser parses the description and a list of some but not all of the data categories job parses out of job description to create a job profile can then be matched with candidates. An example list includes: Position Title, Description, Location, Skills, Number of Positions, and Job Description.

Once the job description is parsed, the form is filled and the requirement creation work flow continues. Onblick posts to multiple selected job boards like Career Builder, Dice and Techfech with one submission. Recruiters need to post a job on OnBlick because the posting reaches out to multiple leading job boards with just one click. Once the job is posted then the recruiter can select what all job boards it needs to appear at.

Recruiter can view all requirements, i.e. open or close requirements or draft format to view more details about that requirement. The requirement view shows the details about the requirement like the requirement name, location, assigned on, last modified on, current status of the requirement, account manager for this requirement, an option to edit the requirement if the recruiter is willing to do so etc. Recruiter can see the Onblick profiles, profiles from the job boards (Dice, Career Builder, Techfetch etc). In Onblick profiles, the matching profiles against this requirement, candidates who viewed this requirement so far, job seekers that applied to this requirement and the like. FIG. 14 is the view in which recruiter can view the job seeker profile, can see the compatibility match, and can call/chat/email to this profile as shown by the corresponding system page/UI 1402.

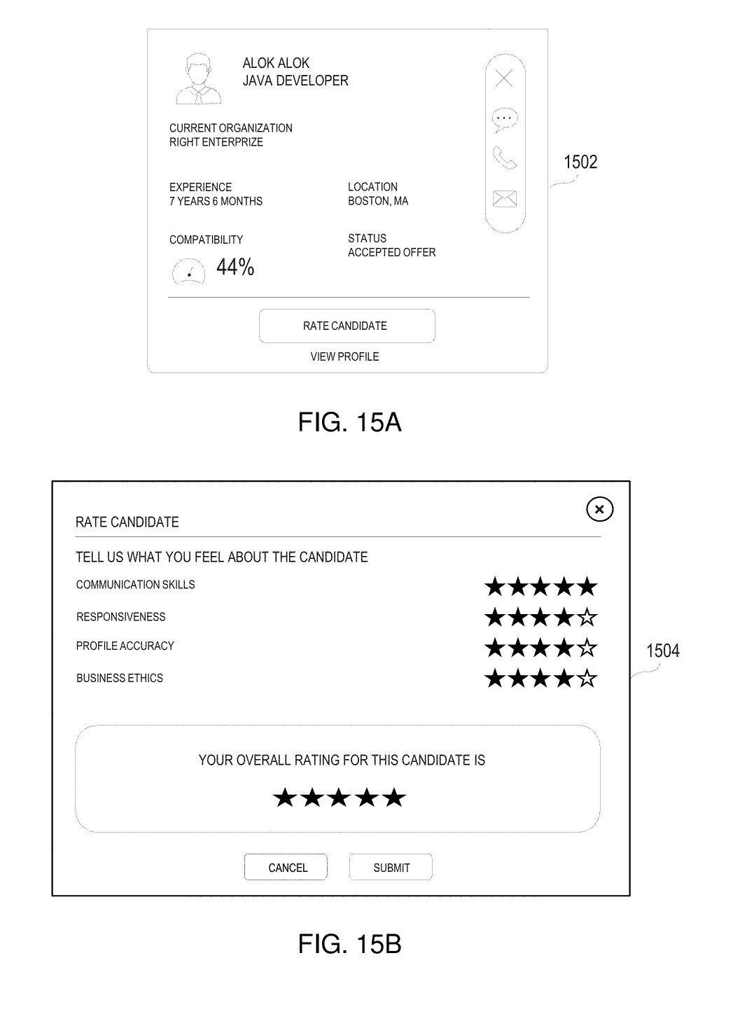

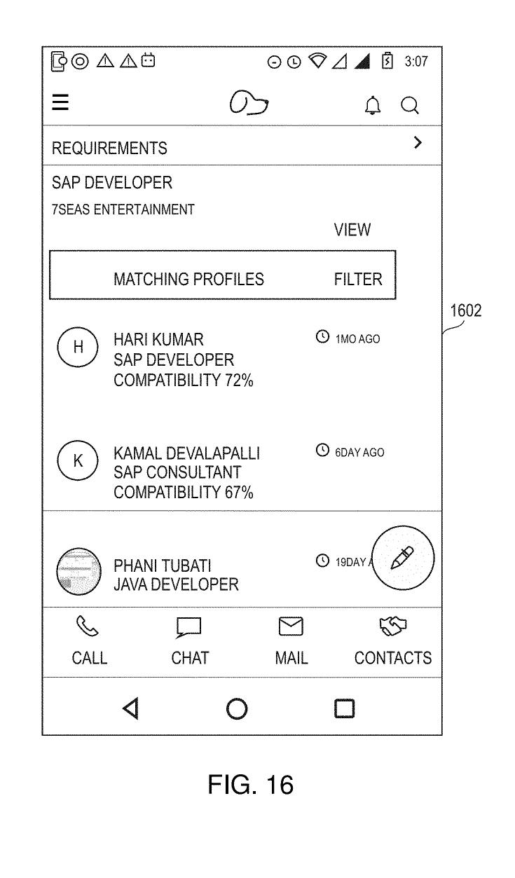

Matching Profiles as shown in FIG. 16 with a UI 1602. Where they can see the matching profiles in the market relative to job skill set, technology also he can get precise information related to the job seeker profiles. Various filters are available for filtering profiles. Examples of the filters include, but are not limited to, tax terms, work permit types, experience, and location. The recruiter can even share the requirement with the job seekers. Recruiter can add notes to be attached along with the email that goes with the share requirement. Also, if the profile is applied, recruiter either can reject or submit this candidate to the AM (account manager). The recruiter can see applicants, shortlisted profiles and other variations. For each view the content seen by the recruiter may differ. In the shortlisted profile view, the recruiter can view the profile, can see the compatibility match, can rate and can call/chat/email to this profile as shown in FIG. 15A with corresponding system page 1502. Also, if the profile is shortlisted and accepted offer, the recruiter can rate the candidate as shown in FIG. 15B with the system page 1504.

The recruiter can import job seekers' resume from different portals and also, collate the status of the applications. The imported resume is parsed to create parsed resume. In addition, the recruiter can share this requirement to an external consultant imported from other job portals, call their phone and email them if required, they also can download the resume for further usage.

There are various filters that will assist the recruiter to narrow down the profiles based on their choice. The filters are available via the different portals or from within OnBlick. The various filters supported include profile last active days, company external consultant working/worked for, skill set, various candidate preferences like employment types, work authorization, annual or daily compensations, travel preferences, relocation preferences, years of technical experience of the profile, their degree, security clearance, and the like.

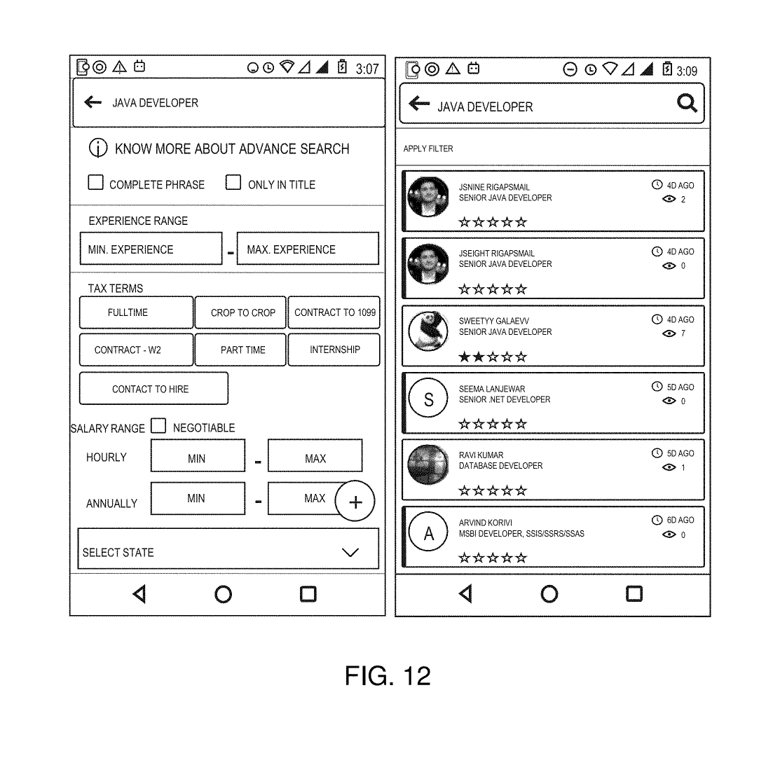

Search Profiles—Recruiter is provided with options to do a generic search and to find other relevant job seeker profiles as shown in FIG. 12. Recruiter can search profiles and to find other relevant profiles. Recruiter is provided with advanced search provisions where they can either select profiles nearby job seeker location, matching or excluding the skills, matching his visa category, pay range etc. Recruiter can view the profile, view the rating, call/chat/email/share one requirement, mark that profile as favorite. Recruiter can view the profile, call/chat/email/share the requirement with that user, can Download the resume, mark the profile favorite and see the uploaded resume versus parsed resume.

Activity Tracking system—Walkthrough of all the activities taken place in recruiter related activities. Activity manager captures all recruiter activities and syncs every update and event within the application in a time-line format. It also sends timely reminders of appointments and deadlines.

The recruiter also gets to see a section that displays the Onblick contacts, imported consultants, Onblick vendors, imported vendors and company directory where recruiters can filter, see their details and call them if required. Recruiter can see their contact information, activity timeline and view their profiles.

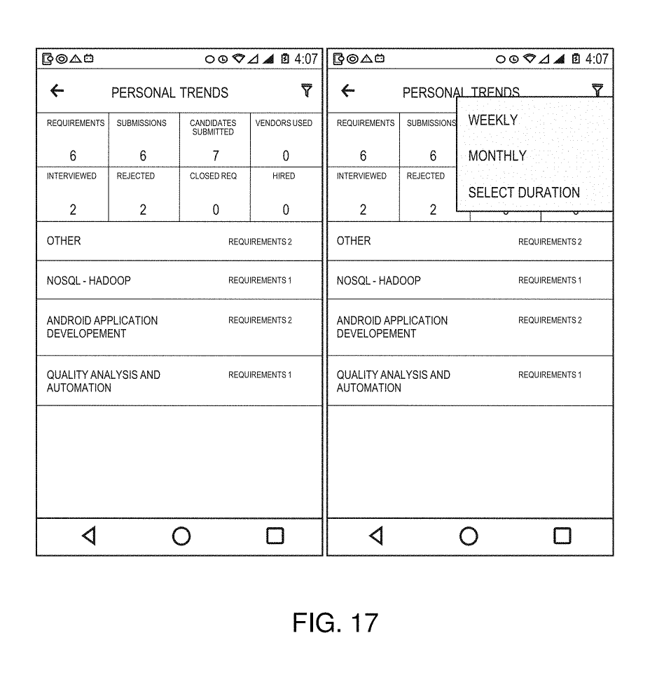

User (here recruiter) is provided with updates related to their requirements, how many requirements created, how many submissions were made, how many interviewed, how many vendors used, how many candidates got closed, rejected, hired against each requirement. Recruiters also can see the requirements split up by category as shown in FIG. 17.

Recruiter has full control on their application and the recruiter can enable/disable settings, such as update profile, turning on/off the feed features to receive notifications, integrate other job boards, feeds settings, profile settings, integrate other job board settings, and change password. The access to external job portals including importing resume etc. can be done using the login details of the external job portal.

Every key activity performed by user is tracked in the system, and with timestamp the activity is highlighted to the users via notifications. In one example, the system shows the last 5 unread notifications as a popup. Notifications button on the landing page will list the notifications. Recruiter can view the various notifications he has received. Clicking on the notification will navigate Recruiter to the relevant page where recruiter can view the more details of the notification and can act accordingly.

FIG. 4C illustrates an exemplary mobile verification page 406 for all the users. FIG. 4D illustrates an exemplary password setup page 408 for all the users. FIG. 4E illustrates an exemplary sign in page 410 for job seekers. FIG. 4F illustrates an exemplary sign in page 412 for Recruiter's/account manager's& Management.

Account managers (AMs) can register themselves by providing various details. After a successful login in to application the account manager will be landing in to the page which is called AM Dash Board. Dash board Contains various sections such as:

Create a new requirement—One of the fundamental use-case for the recruiters is to create a requirement against which they will try to fulfill the profiles.

Requirements—Contain the jobs the recruiters has created, Open, Closed and Auto Drafts. AM can create a requirement in four ways: By filling a form by giving the requirement details. AM can fill the Requirement creation form to put in the details they wanted to create the requirement, by copying details from their email or file and then using those details to paste onto the clipboard to parse automatically or directly forwarding the Email to jobs@onblick.com or by visiting their emails section in OnBlick and against email user will see “create requirement from email”.

AM may select the following details to create a requirement: 1. Client details; 2. End client details; 3. Open positions; 4. Start date; 5. Duration; 6. Job title; 7. Experience Range; 8. Job location; 9. Tax terms allowed for this job; 10. Work Permit required for this job; 11. Pay range; a. Annually, b. Hourly rate or, c. Negotiable; 12. Option to tell the job seekers that this job includes all expenses paid; 13. Option to tell the system that Pay range need to be hidden while viewing this Job; 14. Job Description in HTML Format; 15. key skills required for the Requirement; 16. Technology Category and Sub category; 17. Minimum projects count required as eligibility to apply for this requirement; 18. Order of the Compatibility metrics are calculated; 19. Option to select application repost preference a. Allow vendors to submit only W2 candidates, and b. Enables the Vendors to submit external candidates as well; and 20. The option to disable the Call/Chat facility for this requirement if the recruiter wants to do so. Once all the data is given and continue is indicated, recruiter can review all the details and post.

AM can edit the requirement if they wish to change the requirement details or they can click and create requirement to go ahead create the requirement. Additional step AM will go through while creating the requirement is to assign a recruiter to this requirement. AM can assign himself as a recruiter. AM can copy details from their email or file and then use those details to paste onto the clipboard to parse automatically.

The parser parses the description and here is a list of some but not all the data categories job parses out of job description to create a job profile that can then be matched with candidates: Position Title, Description, Location, Skills, Number of Positions, and Job Description. Once the job description is parsed, it fills the form as above and the requirement creation work flow continues as above.

AM can browse through the requirements to see view more details about that requirement with the activity bar showing the current status of the requirement. AM sees the view that shows the details about the requirement like the requirement name, location, assigned on, last modified on, current status of the requirement recruiter assigned for this requirement. Options to edit the requirement, Close the requirement and changing the recruiter are there if the AM is willing to do so. AM can view the profile, can see the compatibility match, and can schedule the interview or reject the candidate

Internal consultants—Where they can see the matching profiles in the market relative to job skill set, technology also he can get precise information related to the job seeker profiles. This section shows the internal consultants which are matching for each requirement and recruiter can see all the internal consultants as well. It also shows how long the candidate is in hot-listed for that requirement. It also shows the placed candidates by this AM.

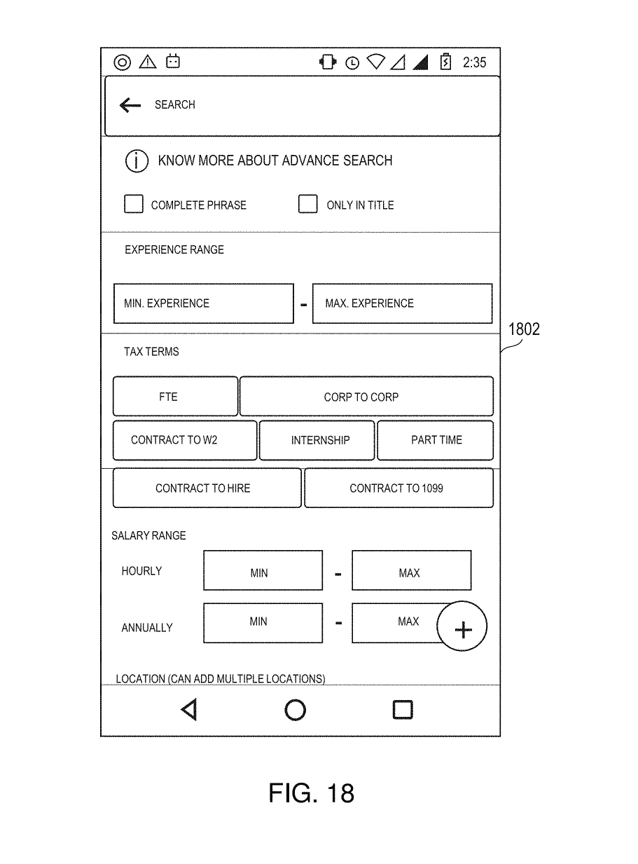

Search Jobs—AM is provided with options to do a generic search and to find other relevant jobs. Account manager can search jobs and to find other relevant information related to the jobs. AM is provided with advanced search provisions as shown in FIG. 18 by an exemplary UI 1802 where they can either select jobs nearby location, matching or excluding the skills, matching the visa category, experience, pay range etc. Once the jobs are listed, AM can view the job details by clicking the View Job.

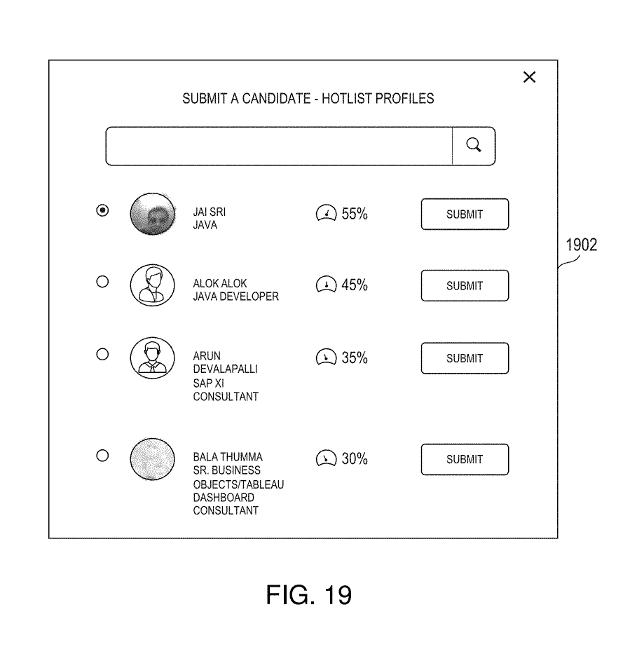

Account manager can search job, view job details as like job seeker, so that he can submit any of the Hot-listed candidates. AM can submit an internal candidate to this job as shown in FIG. 19 with a UI 1902.

Activity Tracking system (ATS)—Walkthrough of all the activities taken place in recruiter related activities. Activity manager captures all AM activities and syncs every update and event within the application in a time-line format. It also sends timely reminders of appointments and deadlines. He can create and track the calendar events and invite the contacts for the same. Account manager can view the activity of a particular day by selecting date from date picker of the ATS.

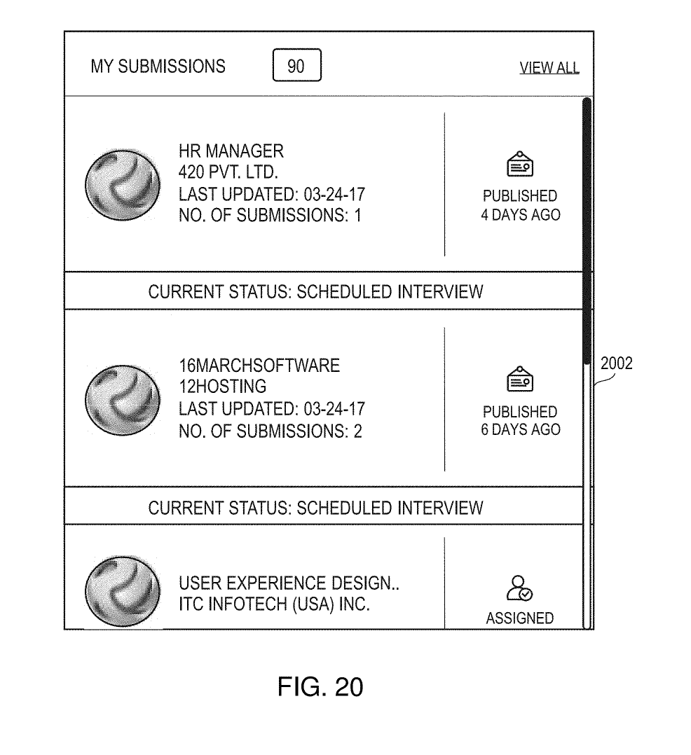

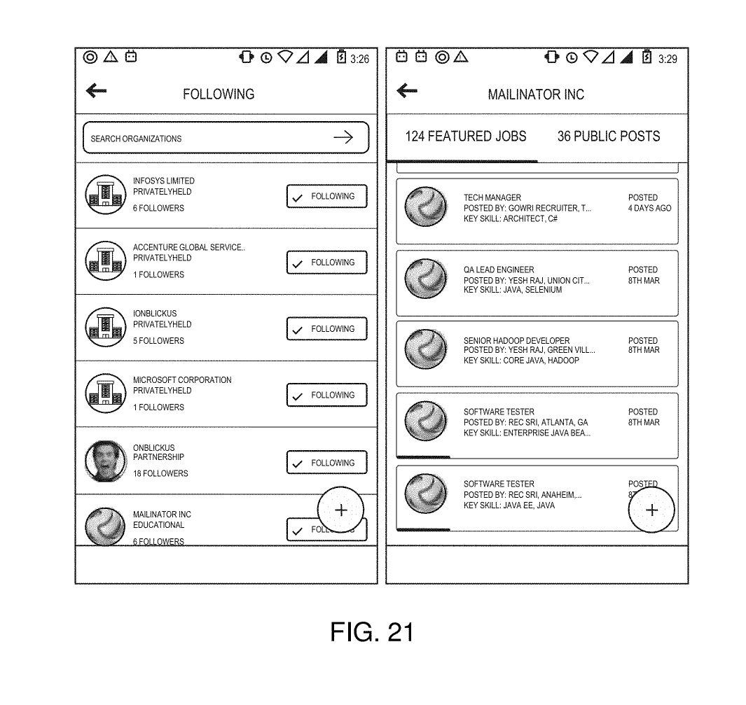

Submission is application of the internal candidate who is on bench to the Clients. As soon as AM submits a candidate to a job that he thinks is more relevant, in the background job application gets created and notification gets triggered to the candidate. A section that displays all the submissions made by the AM with a drill down to more details about the submissions is shown by a UI 2002 in FIG. 20. OnBlick supports Internal and External Feeds, while internal feeds let employees of Organization be posted of the updates, external feeds keep all following consultants posted with updates. He has an authority to edit or delete internal feeds published to him Internal feeds posted by him can be edited or deleted by the controls provided on the feed view. User can perform the below operations in feeds screen: Post an internal feed, Edit/Delete feed posted by him etc. The tool contains list of all jobs from the organizations AM is following as well as organizations which they may like to follow (suggested organizations). The following is shown in FIG. 21.

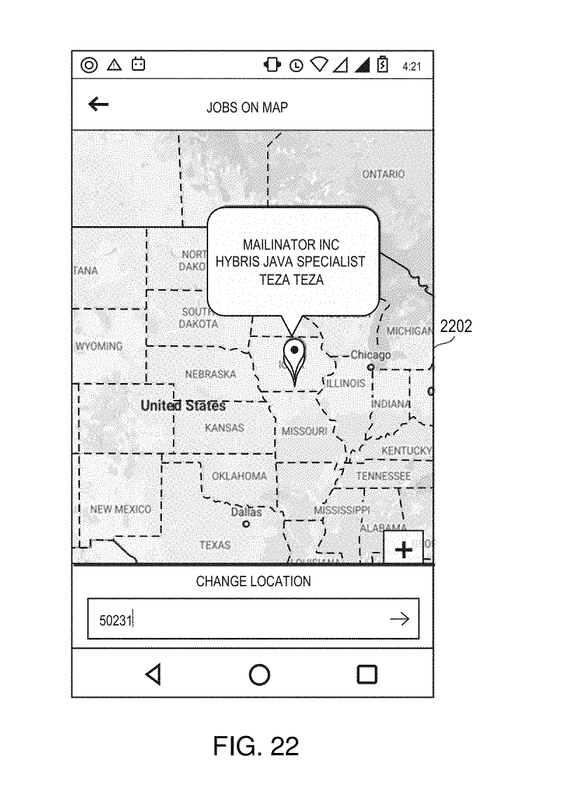

OnBlick application provides the feature to view the jobs posted in different locations. Account manager can search jobs by entering the zip code of the desired location as shown in UI 2202 of FIG. 22. Application will display the available jobs with the brief information about the job. Account manager can tap on desired job to view the complete details of the job.

Contact manager is a section that displays the hotlist consultants, external consultants, imported consultants, Onblick clients, other clients and company directory where recruiters can filter, see their details and call them if required. Other consultants include hotlist consultants, external consultants, imported consultants, OnBlick clients, and company directory. AM can share the hotlist with Onblick client or imported clients. AM can see their contact information, activity timeline and view their profiles. User (here AM) is provided with updates related to their requirements, how many requirements created, how many submissions were made, how many interviewed, how many vendors used, how many candidates got closed, rejected, hired against each requirement etc. This includes Requirements, Submissions/Requirements, Candidates submitted, Interviewed, Rejected, Closed Requirements, and Hired.

AM also has access to the page that shows all the recruiters and their activities for the AM to see and track. Tapping on a particular recruiter will open detailed page where he can see the following information along with the options to communicate (Call, Chat, and Mail). The information includes:

1. Number of total requirements
2. Number of open requirements
3. Number of closed requirements
4. Details of the open and closed requirements assigned to recruiter
AM accesses the page that gives all the open requirements, profiles submitted, candidate interviewed, rejected, hired and closed requirements for a recruiter within a particular time period. AM can view recruiter details and can call call/chat/email that recruiter. AM has full control on their application. They can enable/disable settings such as user settings, update profile, profile settings, turning on/off the feed features to receive notifications, change password and the like. Admin (administrator) is an employee of subscribed organization. Admin have administrative privileges for add/removing employees, send out feeds etc. The following are the features:
1. Readily set up the organization
2. Sets up goals for employees
3. Create public feeds for the organization
4. Add/Remove a new employee/another admin

### 5. Import Consultant Database

6. Monitors the employee split-up of their employees,
7. Tracks the requirements status,
8. Monitors the hotlist

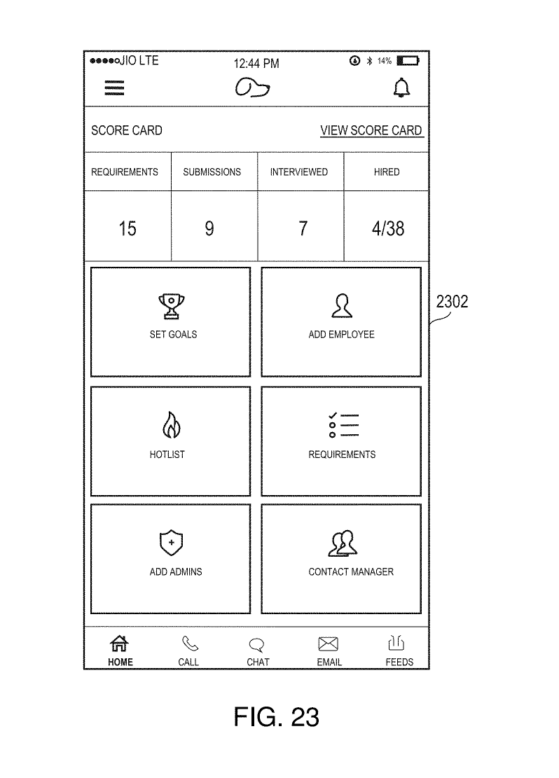

Registration of Employer is little bit different from Registration of Job Seeker. For an employer, system expects following details: Role selection, First Name, Last Name, Work Email, Organization Name, and Mobile Number. After a successful login subsequently user will be taken to the dashboard page where he can view the glance of score card along with the following options: Set Goal, Add Employee, Hotlist, Requirements, Add Admins, Finance, Contact Manager, Human Resource and the like as exemplarily shown in UI 2303 of FIG. 23. Scorecard feature will detail the requirements vs. productivity of the organization. User has an option to view the employee split up which will help to track the productivity of the employees. Filter option can be used to track the previous date progress.

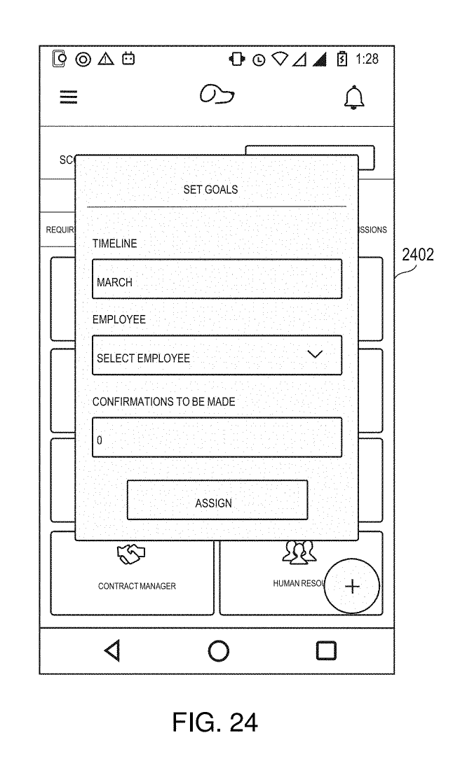

Set Goals feature, as shows in FIG. 24 with a corresponding UI 2402, is used to set the targets to achieve by their employees. Tapping on set goals button will prompt the user with a dialog box where he can choose the employee from the dropdown list and set the confirmations that he need achieve. A notification will be sent to the concerned employee about the new target via push notifications and he can check the targets in their scorecard. Admin has the authority to add new employees to their organization. This feature can be accessed from the ‘Add Employee’ option on the dashboard. User need provide the following credentials to register a new user. a. Employee Type, b. First Name, c. Last Name, d. Official email address, e. Personal email address, and f. Official phone number. A welcome mail and set password mail will be sent to registered email address and user can set the password to access the application.

Hotlist feature lists all the hotlist candidates in the organization with the below mentioned fields: Name of the candidate, Designation, and Location of the candidate. User can communicate (call, chat and mail) and view the past activities with the candidate by accessing the detail page of the candidate. Clicking on the Requirements button will navigate user to the requirements page where he can view all requirements details partitioned into four tabs based on the timelines. Application will show Today, Weekly, Monthly and Yearly data along with requirements grouped by the clients.

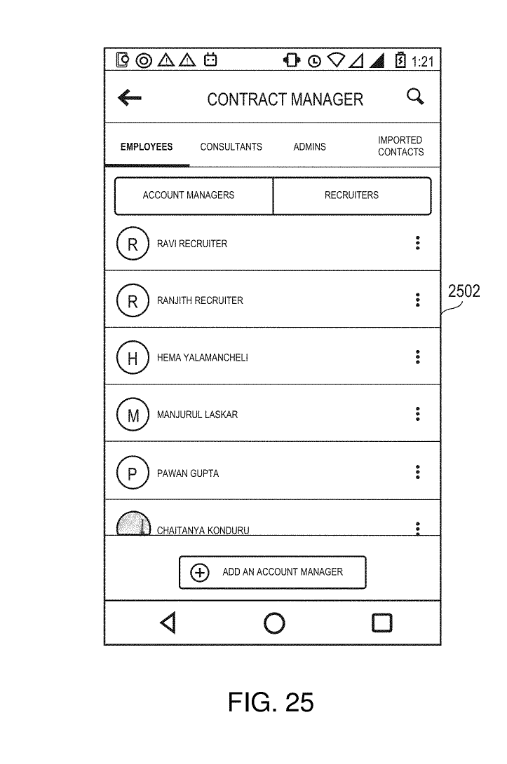

Application may allow maximum of 3 admins for every organization. Selecting ‘Add Admins’ button will prompt user with form to enter new admin credentials. User need to provide following credentials to add new admin: First Name and Last Name, Title, Official email, Personal email, and Mobile number. On successful registration, application will send OnBlick welcome mail and password reset mail to the registered new user. All contacts along with interactions (calls, chats, mails and updates) with them are automatically saved in contact manager, so one can view them anytime and as number of times! Build your own vendor network with all the vendors added into contact manager. Contact manager may display the four types of contacts separated in tabs, as shown by UI 2502 in FIG. 25, employees, consultants, admins, and imported contacts.

Notifications button on the landing page will list the notifications. User can view the various notifications he has received. Clicking on the notification will navigate user to the relevant page where user can view the more details of the notification and can act accordingly. Hamburger menu will navigate user to profile page where he can view and edit his personal information. Company profile page displays comprehensive details of the organization segregated into following sections: Company bio, Specialties, Website, Type, Head Office, Contact Email, Board Number, and Founder. User has an option to edit and save the details by the edit/save controls located at the header of the page. Tapping on edit button will enable the edit mode and user can do the necessary changes and save the details. General settings can be accessed from the settings button of the profile page. Here application provides the options to change password and logout from the application.

Admin has an ability to define the integrations to other job boards DICE, TechFetch etc. They need to provide client specific information to be able to enable integration for the OnBlick. OnBlick app (the app, the application or also referred to as the tool or system) provides the in app features that helps user to communicate with employees, consultants and other admins and view the feeds posted by the self and other employees. Features can be accessed by tapping on the floating button provided in various screens of the application. For example, a. In App Call, b. In App Chat, c. In App Mail, and d. Feeds. User has an option to access the mail service from the application. Tapping on the ‘Mails’ button from the floating button will navigate user to the in app mails where user can see the inbox mails and can reply to the mails he has received, save as drafts and compose and send new mails.

OnBlick app provides option to post and read the feeds of the organization. User can view the internal and public feeds segregated in to sections. He has an authority to edit or delete feeds published by self and other employees of the organization. User can choose the ‘show my feeds’ option from the header to view the feeds posted by him Each feed item can be edited or deleted by the controls provided on the feed view. User can perform the below operations in feeds screen: Post a new feed, Edit/Delete feed, and View the self posted feeds. User can talk with contacts by tapping on the call button provided at the various relevant pages of the application. The call screen will show the relevance of the call for both caller and receiver. User can chat with their contacts by tapping on the chat button available at contacts pages. OnBlick application will show the relevance of the chat for both the parties on their chat window. In absence of the opponent, AI (artificial intelligence) chatbot will trigger and answer the queries based on the preferences set by the opponent. Here user can also share the files of different formats along with the text information.

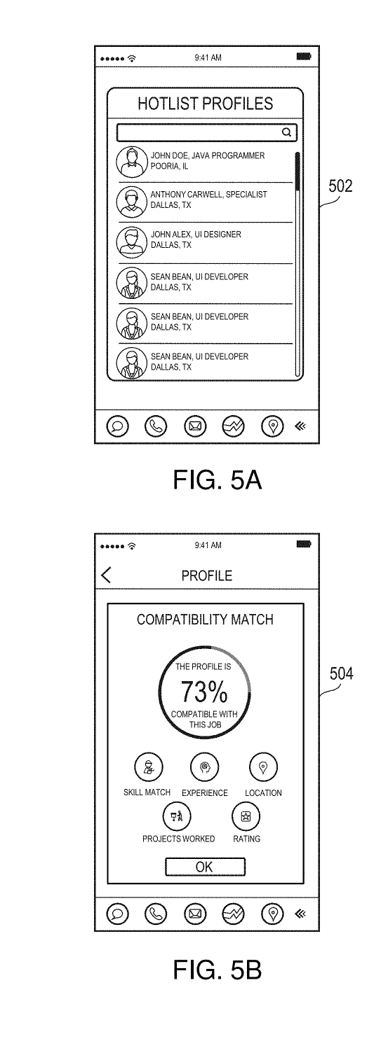

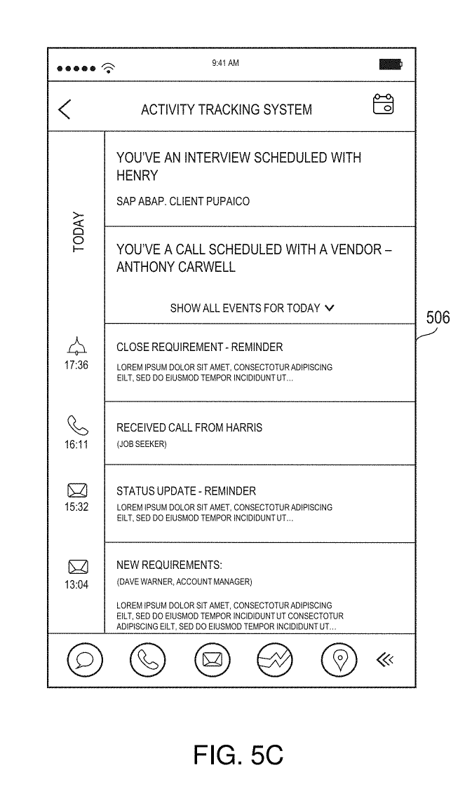

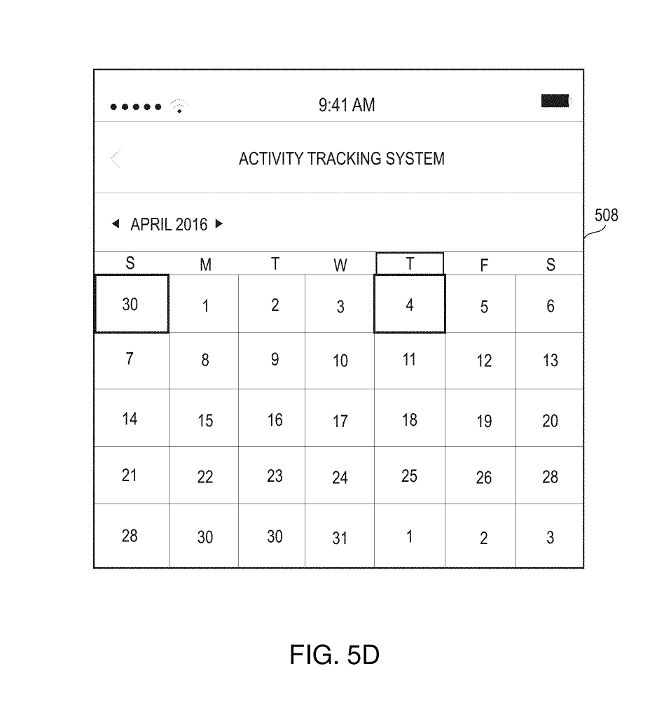

FIGS. 5A-5D are exemplary screenshots of unique features of the method described herein, according to the embodiments as disclosed herein. FIG. 5A illustrates an exemplary list of Hotlist profiles 502. Every organization will have consultants who are essentially job seeker. Account manager of the organization takes the responsibility of placing these consultants on different project assignments. So, account manager should have an idea of who are the consultants who needs an immediate attention and ready to be placed for project assignments. Such consultants are referred as HOTLIST PROFILES.

FIG. 5B illustrates an exemplary compatibility match of profiles with options to view their compatibility against skill match/experience/location/projects worked/rating on the system page 504. FIGS. 5C and 5D illustrate exemplary activity tracking system which allows the users to track their daily activity on the system pages 506 and 508.

### System Block Diagram

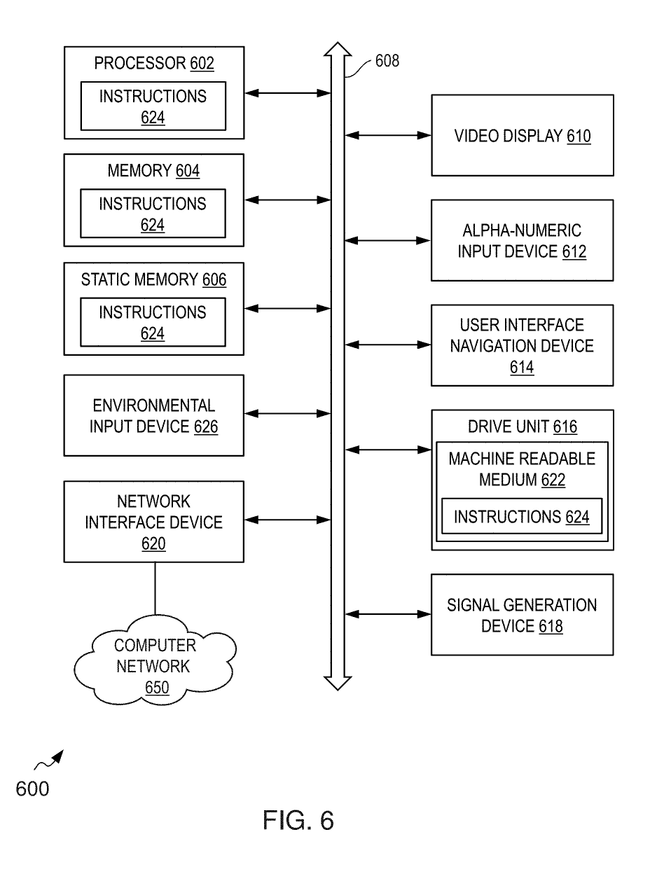

FIG. 6 is a block diagram of a machine in the example form of a computer system within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker), and a network interface device 620. The computer system 600 may also include a environmental input device 626 that may provide number of inputs describing the environment in which the computer system 600 or another device exists, including, but not limited to, any of a Global Positioning Sensing (GPS) receiver, temperature sensor, a light sensor, a still photo or video camera, an audio sensor (e.g., microphone), a velocity sensor, a gyroscope, an accelerometer, and a compass.

### Machine-Readable Medium

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “non-transitory machine-readable medium” shall also be taken to include any tangible medium that is capable of storing, encoding, or carrying instructions for execution by the machine and that cause the machine to perform anyone or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 624 may further be transmitted or received over a computer network 650 using a transmission medium. The instructions 624 may be transmitted using the network interface device 620 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise JavaBeans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its sub-standards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

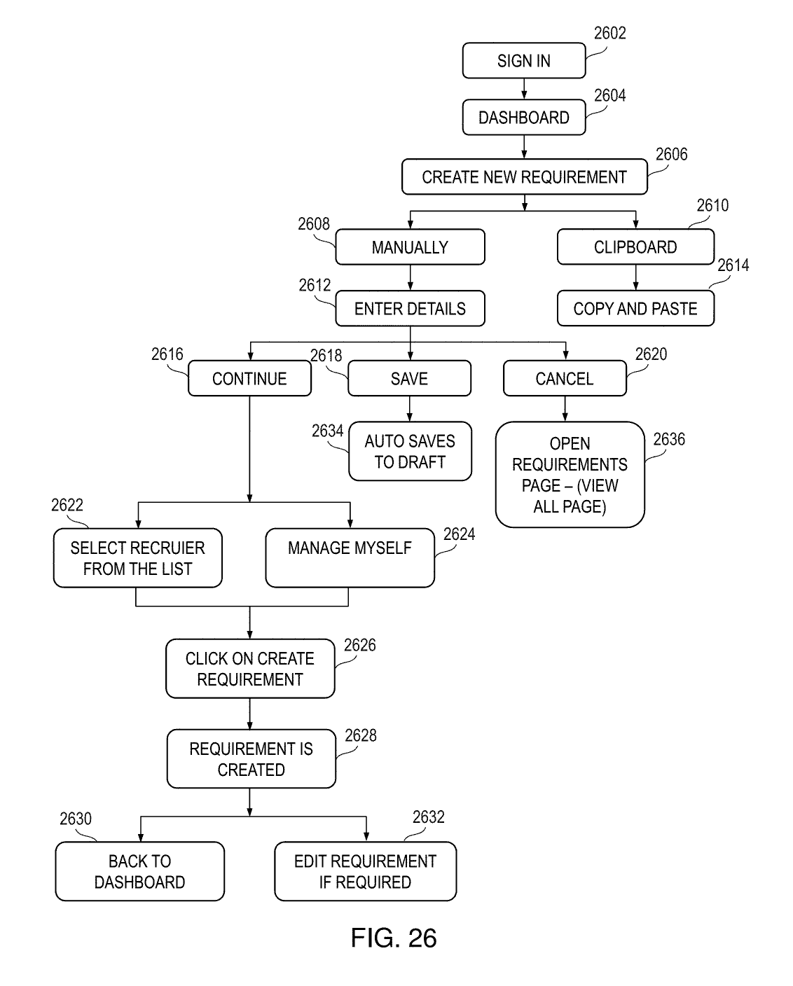

FIG. 26 illustrates a method for creating a requirement by a user such as an AM, according to the embodiments as disclosed herein.

At step 2602, the AM signs into the job tool or portal or board.

At step 2604, a dashboard, as described earlier, is provided to the AM.

At step 2606, a request for creating new requirement is initiated.

At step 2608 and 2612, the details needed for creation of new requirement are added manually. While, at step 2610 and 2614, the process of entering details is automated and the details are copy pasted from clipboard.

Various options are then provided after receipt of the details by the job tool. Examples of the options include, step of saving at step 2618, step of canceling at step 2620, and step of continuing at step 2616.

In case of saving at step 2618, the method moves to auto saving of the draft at step 2634. In case of canceling at step 2620, the method moves to open requirements page at step 2636.

In case of continuing at step 2616, the method either moves to selection of recruiter from a list at step 2622 or at managing details myself option at step 2624.

At step 2626, an input or click indicating creation of requirement is received.

At step 2628, the job requirement is created.

At step 2630, the tool moves back to dashboard display.

At step 2632, the job requirement can be edited, if required.

It is to be appreciated that the process is explained from AM perspective but a similar method can be followed for any other user of the tool interested in creating a new requirement.

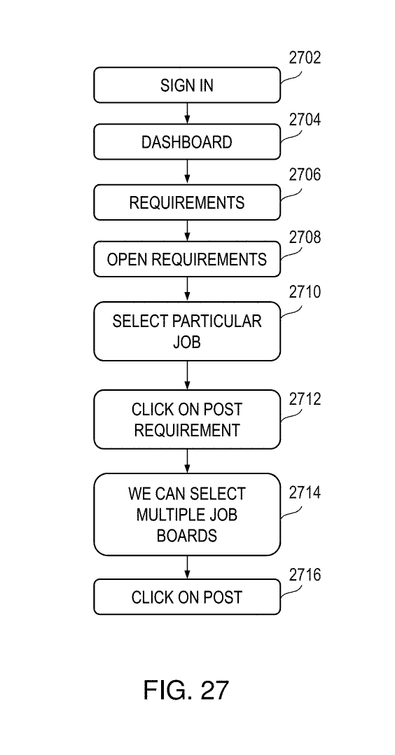

FIG. 27 illustrates a method for posting a requirement, according to the embodiments as disclosed herein.

At step 2702, the user, i.e. the AM or the recruiter or anyone else interested in posting job, signs in the job tool.

At step 2704, a dashboard is displayed to the AM.

At step 2706, a list of requirements is displayed to the AM.

At step 2708, the tool opens a requirement in response to a request or an input for the same received from the AM.

At step 2710, an input indicating selection of a job is received.

At step 2712, another input or click on post requirement is received.

At step 2714, selection of multiple job boards where the job to be posted is received.

At step 2716, the job is then posted on selected job boards.

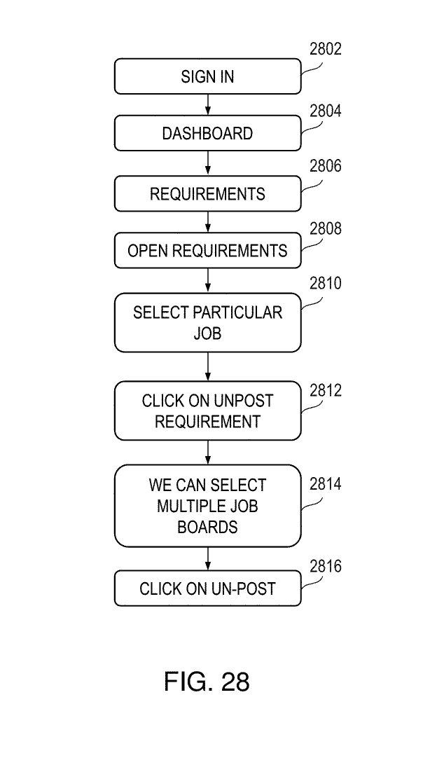

FIG. 28 illustrates a method for un-posting a requirement, according to the embodiments as disclosed herein.

At step 2802, the user, i.e. the AM or the recruiter or anyone else interested in un-posting job, signs in the job tool.

At step 2804, a dashboard is displayed to the AM.

At step 2806, a list of requirements is displayed to the AM.

At step 2808, the tool opens a requirement in response to a request or an input for the same received from the AM.

At step 2810, an input indicating selection of a job is received.

At step 2812, another input or click on un-post requirement is received.

At step 2814, selection of multiple job boards where the job is to be un-posted is received.

At step 2816, the job is then un-posted on selected job boards.

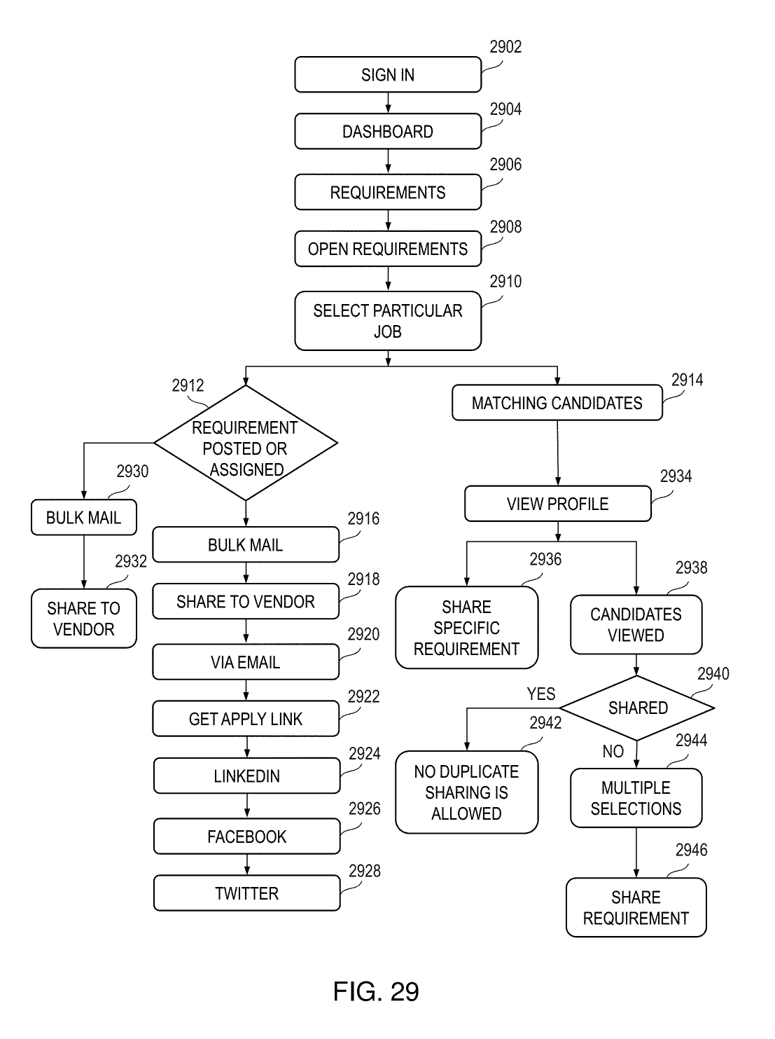

FIG. 29 illustrates a method for sharing a job through jobs, according to the embodiments as disclosed herein.

At step 2902, the user, for example the AM, the recruiter or anyone else interested in managing job, signs into the tool.

At step 2904, the dashboard is displayed to the AM.

At step 2906, the requirements are displayed.

At step 2908, input or click is received to open requirements.

At step 2910, an input indicating selection of a particular job is received.

At step 2912, the job requirement is posted or assigned.

At step 2930 (if at step 2912 the job requirement is assigned and not posted) or at step 2916 (if the job requirement is posted), bulk email including the job requirement is sent.

At step 2932 or step 2918, the job requirement is shared with a vendor. The job requirement can also be shared in various forms, for example via email at step 2920, via a link at step 2922, via various portals such as LinkedIn® at step 2924, via Facebook® at step 2926, and via twitter at step 2928.

In some embodiments, at step 2914, after selection of the particular job at step 2910 the AM gets to see list of matching candidates at step 2914. The matching candidates list can be automatically generated by the tool as described herein in another figures.

At step 2934, an input is received to view profile of a matching candidate.

At step 2936, specific requirement is shared.

At step 2938, a list of candidates is displayed and viewed.

At step 2940, the list is shared.

At step 2944, multiple selections are made and the requirement is shared at step 2946.

At step 2942, no duplicate sharing is allowed if it has already been shared.

In some embodiments, if sharing happens through bulk mail then job seeker will receive only mail. It won't appear in shared jobs.

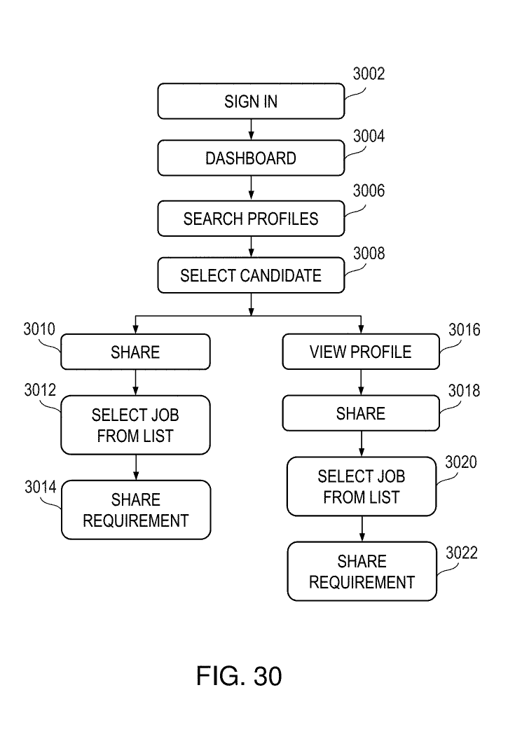

FIG. 30 illustrates a method for sharing a job through candidates, according to the embodiments as disclosed herein.

At step 3002, the user, such as the AM, recruiter, administrator or any other person interested in sharing the job, signs into the tool.

At step 3004, a dashboard is displayed to the user.

At step 3006, an input indicating search for profiles is received. The candidate profiles are searched and displayed.

At step 3008, an input or click is received to indicate candidate selection.

At step 3010, the list of jobs is shared via different modes, for example email.

At step 3012, an input indicative of job selection is received. The job is selected from the list. At step 3014, the requirement is shared.

In some embodiments, at step 3016 the profile of the candidate is viewed. After viewing, at step 3018, the list of jobs is shared.

At step 3020, an input indicative of job selection is received. The job is selected from the list. At step 3022, the requirement is shared.

Job Seeker (candidate) will receive a mail and notification. He also can view in shared jobs.

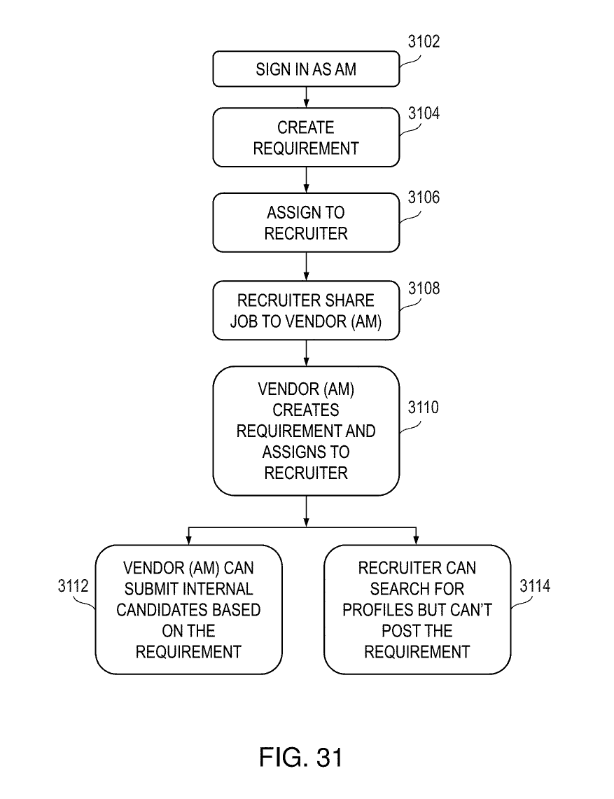

FIG. 31 illustrates a method allowing W2, according to the embodiments as disclosed herein.

At step 3102, the AM signs into the tool.

At step 3104, a requirement is created as explained earlier.

At step 3106, the job requirement is assigned to a recruiter.

At step 3108, the job requirement is shared by recruiter with a vendor (AM).

At step 3110, vendor (AM) creates requirement and assigns to the recruiter.

At step 3112, the vendor (AM) can submit internal candidates based on the requirement.

At step 3114, recruiter can search for profiles but cannot post the requirement.

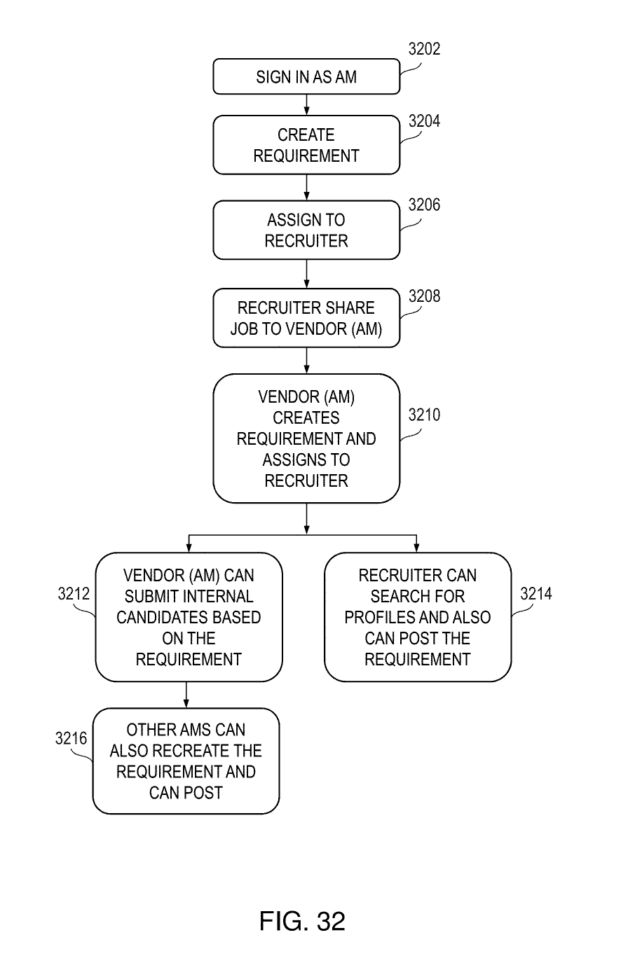

FIG. 32 illustrates a method allowing third party to participate in job management, according to the embodiments as disclosed herein.

At step 3202, the user signs into the tool as AM.

At step 3204, a requirement is created.

At step 3206, the requirement is assigned to recruiter.

At step 3208, the recruiter shares the job requirement with vendor (AM)

At step 3210, vendor (AM) creates requirement and assigns it to the recruiter.

At step 3214, the recruiter can search for profiles and also can post the requirement.

At step 3212 vendor (AM) can submit internal candidates based on the requirement.

At step 3216, other AMs can also recreate the requirement and can post it.

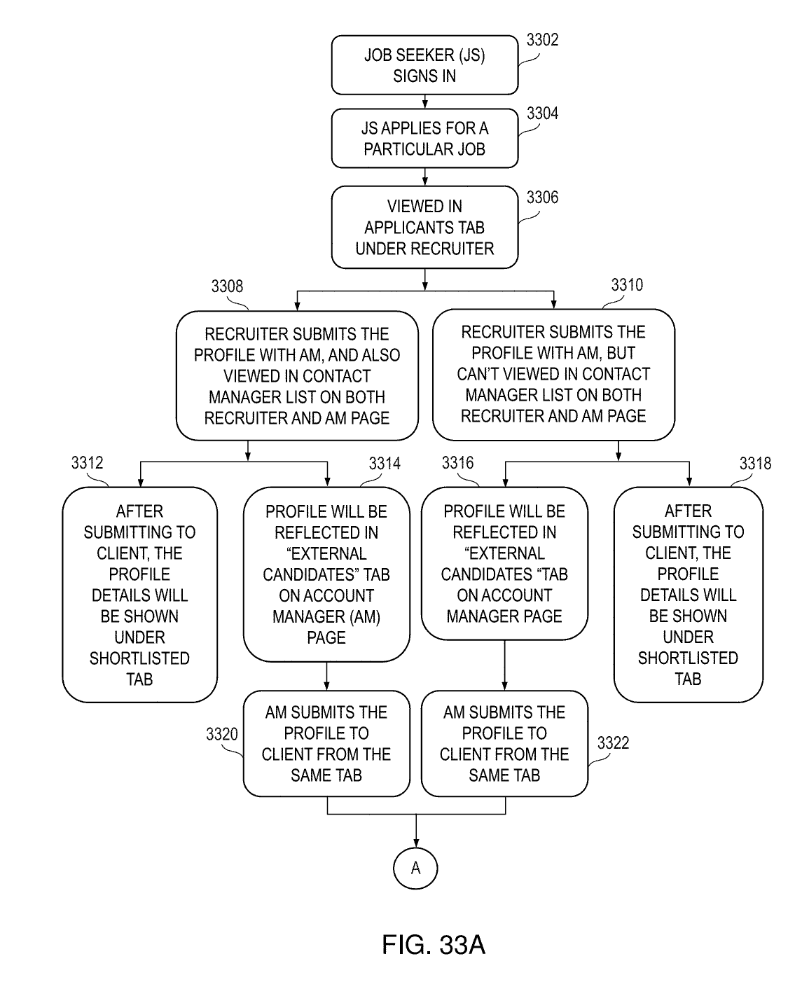

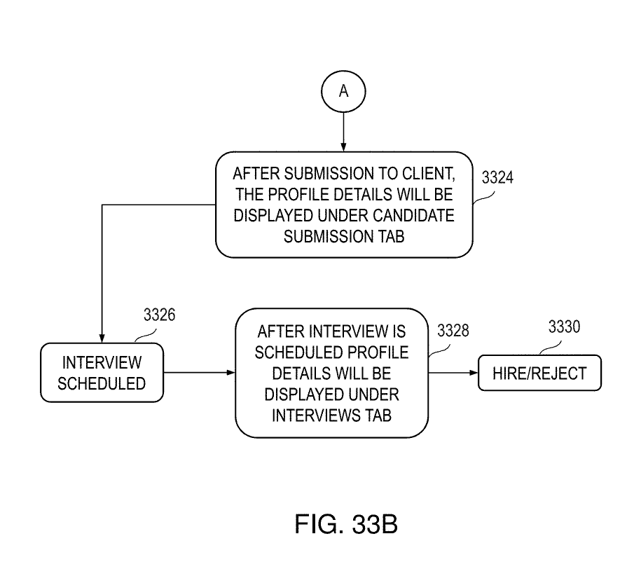

FIGS. 33 (33A and 33B) illustrates a method for applying for job, according to the embodiments as disclosed herein.

At step 3302, a user (job seeker in this case) signs into the tool.

At step 3304, the job seeker applies for a particular hob.

At step 3306, the job is viewed in applicants tab under recruiter.

The workflow differs based on the view available at step 3306. The method moves to step 3308 in case there is a view available at step 3306. Else, the method moves to step 3310 when there is no view.

At step 3308, the recruiter submits the profile with AM. The profile and the submission can be viewed in contact manager list on both recruiter and AM page.

In one embodiment, at step 3312, after submitting the profile to the client, the profile details are made available under shortlisted tab.

In another embodiment, at step 3314, the profile is reflected in external candidates tab on AM's page. At step 3320, AM submits the profile to the client from the same tab. At step 3324, the profile details are displayed under candidate submission tab after the submission to the client. At step 3326, an interview is scheduled. At step 3328, the scheduled profile details are displayed under interviews tab after the interview. At step 3330, the candidate is either hired or rejected.

The method moves to step 3310 when there is no view at step 3306. At step 3310, the recruiter submits the profile with the AM. The profile cannot be viewed in contact manager list on both recruiter and AM's page.

In one embodiment, at step 3318, after submitting the profile to the client, the profile details are made available under shortlisted tab.

In another embodiment, at step 3316, the profile is reflected in external candidates tab on AM's page. At step 3322, AM submits the profile to the client from the same tab and the method moves to the step 3324.

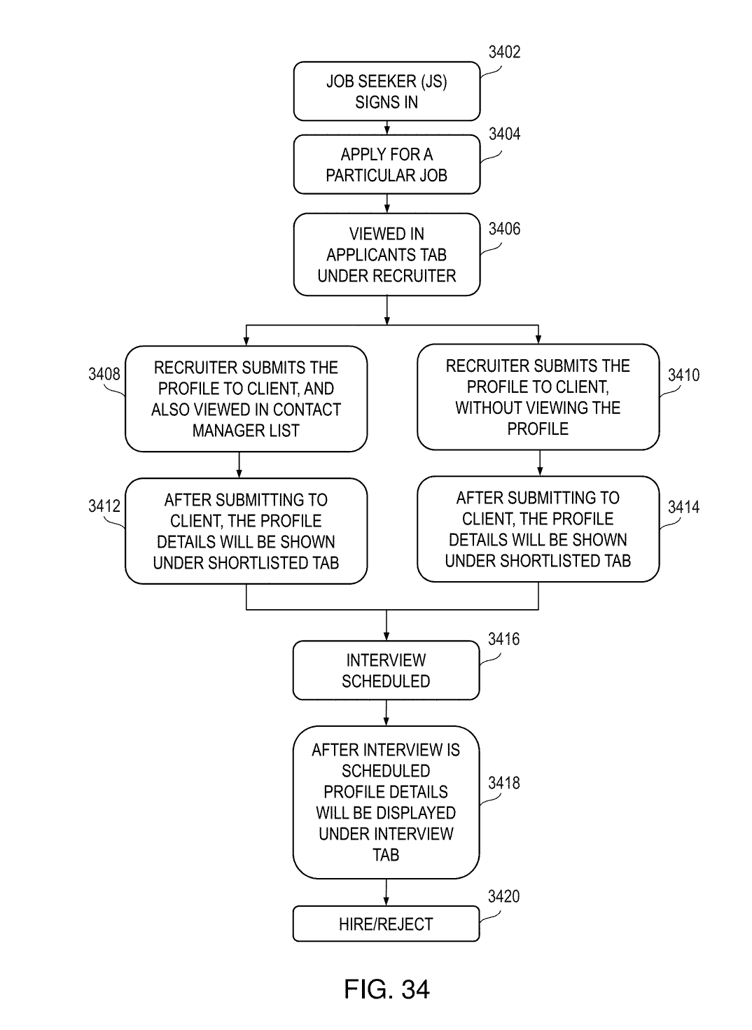

FIG. 34 illustrates another method for applying for job without account manager, i.e. recruiter standalone process, according to the embodiments as disclosed herein.

At step 3402, a user (job seeker in this case) signs into the tool.

At step 3404, the job seeker applies for a particular hob.

At step 3406, the job is viewed in applicants tab under recruiter.

The workflow differs based on the view available at step 3406. The method moves to step 3408 in case there is a view available at step 3406. Else, the method moves to step 3410 when there is no view.

At step 3408, the recruiter submits the profile to the client. The profile and the submission can be viewed in contact manager list.

At step 3412, after submitting the profile to the client, the profile details are made available under shortlisted tab.

At step 3416, an interview is scheduled. At step 3418, the scheduled profile details are displayed under interviews tab after the interview. At step 3420, the candidate is either hired or rejected.

The method moves to step 3410 when there is no view at step 3406. At step 3410, the recruiter submits the profile with the client without viewing the profile.

At step 3414, after submitting the profile to the client, the profile details are made available under shortlisted tab and the method moves to the step 3416.

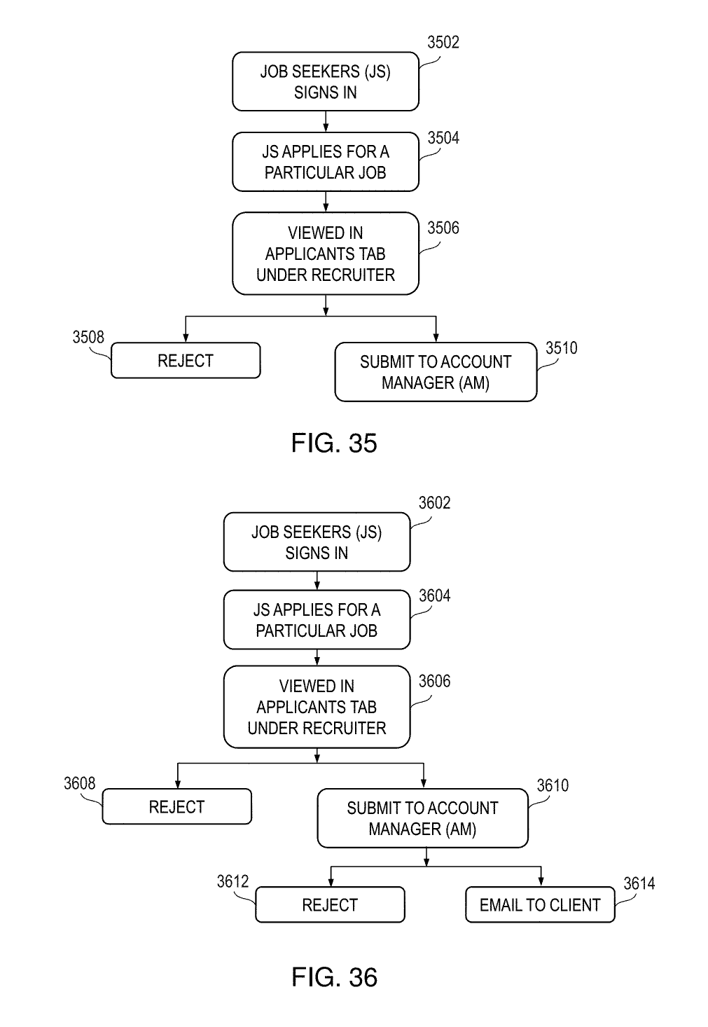

FIG. 35 illustrates a method for candidate rejection by recruiter, according to the embodiments as disclosed herein.

At step 3502, the job seeker signs into the tool.

At step 3504, the job seeker applies for a particular job.

At step 3506, the profile can be viewed in applicants tab of recruiter.

At step 3508, the recruiter rejects the profile or at step 3510, the recruiter submits it to the AM.

FIG. 36 illustrates another method for candidate rejection by AM, according to the embodiments as disclosed herein.

At step 3602, the job seeker signs into the tool.

At step 3604, the job seeker applies for a particular job.

At step 3606, the profile can be viewed in applicants tab of recruiter.

At step 3608, the recruiter rejects the profile or at step 3610, the recruiter submits it to the AM.

At step 3612, the AM either rejects the profile or at step 3614, the email is sent to the client for further process.

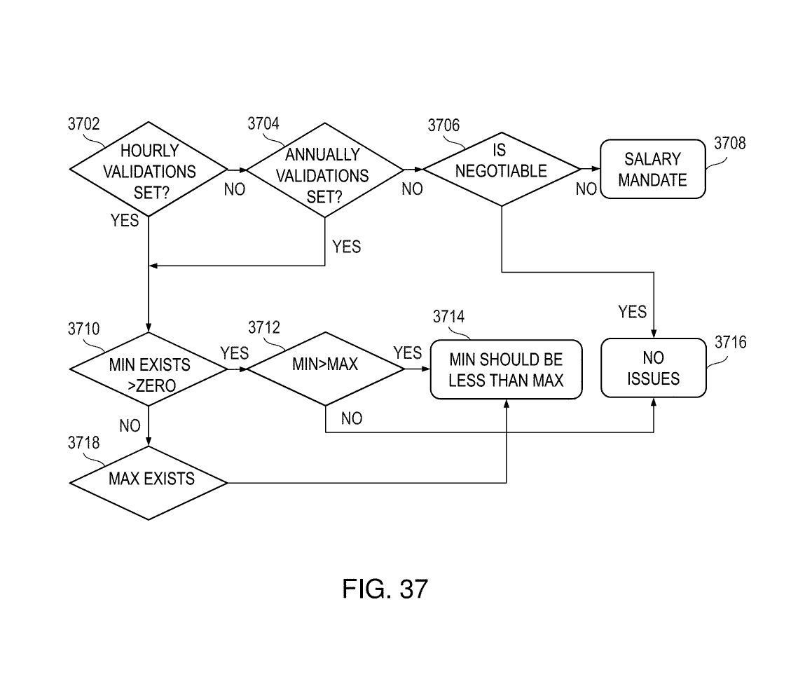

FIG. 37 illustrates a method for pay validation, according to the embodiments as disclosed herein.

Basic Validations include:

Minimum/Maximum salary—always greater than zero;
Maximum salary should be either greater than or equal to minimum salary;
Users are allowed to enter minimum 1 digit and maximum of 3 digits for Hourly Salary;
Users are allowed to enter minimum 4 digits and maximum of 6 digits for Annual Salary;
Users are allowed to enter only integers;
Users are not allowed to start integers with zero; and
Users are allowed to enter only positive integers.

If Negotiable box is checked:

It should not be a mandatory to user to enter values if negotiable box is checked. There shouldn't have any validation too proceed further. (In case all fields are empty in pay);
Users are also allowed to enter values in the fields though the negotiable box is checked. And once the values are entered then we should have basic validations; and
Once we are entering value in minimum field, then it should be a mandatory for recruiter to enter value in Maximum field, vice versa. And basic validations should be the same.

If Negotiable box is not checked:

It should be a mandatory for user to enter values in the pay fields. And all other basic validations are applied.

At step 3702, a check is made to determine if there are hourly validations set.

At step 3704, a check for annual validations set is done if the hourly validations are not set.

At step 3706, a check is made if the annual validations are negotiable. If no then at step 3708 no salary mandate is concluded. Else, at step 3716 no issues are concluded.

At step 3710, a check is made to determine if minimum that exists is greater than zero, if the check at step 3702 or at step 3704 results in Yes. If the check at step 3710 results in Yes then at step 3712 a check is made to determine if minimum is greater than maximum. If no, then no issues are concluded at step 3716, else at step 3714 it is concluded that minimum should be less than maximum.

If step 3710 results in No then a check is made if maximum exists. The method then moves to step 3714.

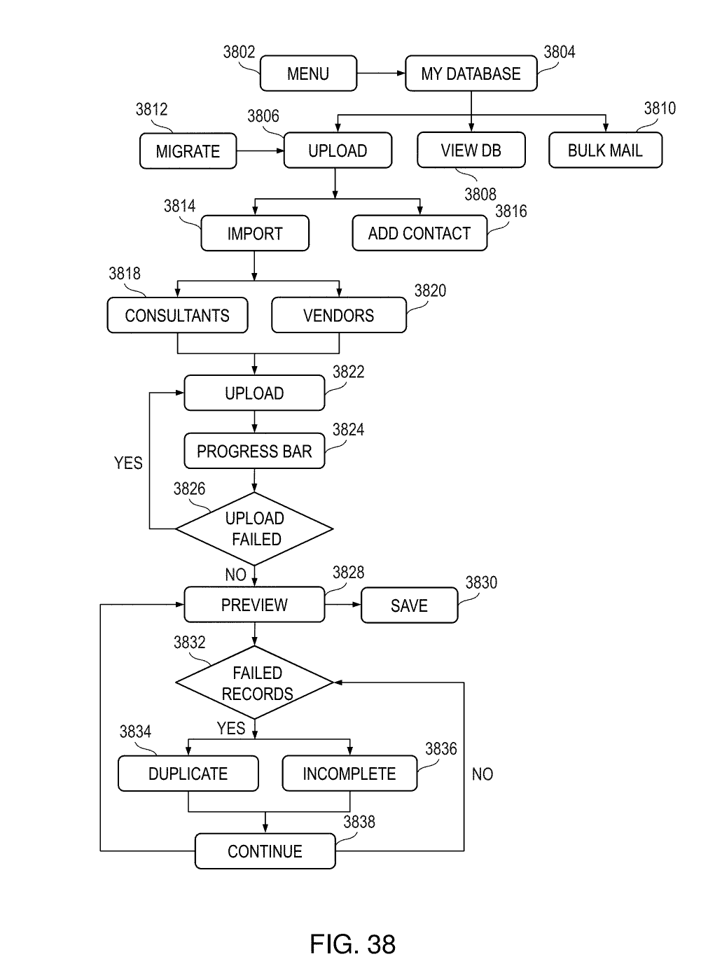

FIG. 38 illustrates a method for bulk upload, according to the embodiments as disclosed herein.

At step 3802, menu is accessed or displayed. At step 3804, database is accessed. Various options include upload at step 3806 via migrate at step 3812, view database at step 3808, and bulk email at step 3810 are seen.

In illustrated embodiment, the bulk upload option at step 3806 is selected and the method moves to providing options of import at step 3814 and add contact at step 3816. Once import is selected then the options are consultants selection at step 3818 and vendors at step 3820. Selection of either leads to step 3822 for upload. The upload begins at step 3822 and the progress bar is seen at step 3824. If upload fail is detected at step 3826 then method moves to step 3822, else at step 3828 preview is seen and saves at step 3830.

At step 3832, a check is made to determine if there are failed records. If no then method moves to step 3838 to continue further, else the method moves to step 3834 for duplicates or step 3836 for incomplete ones. The method then moves to step 3838 for continuing further.

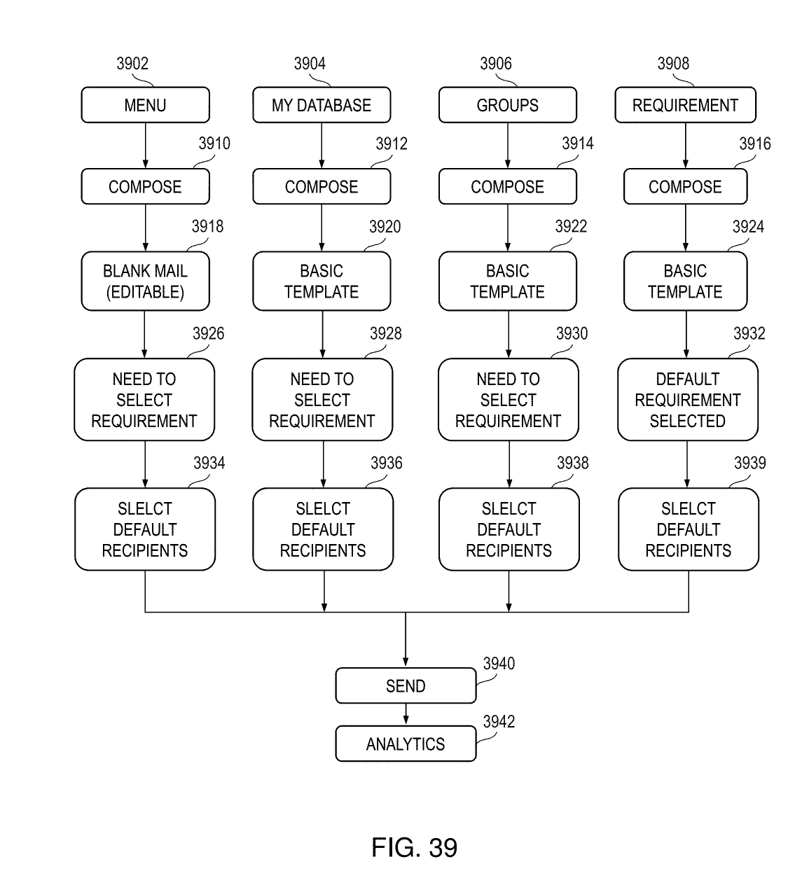

FIG. 39 illustrates a method for bulk mailing, according to the embodiments as disclosed herein.

The bulk mailing could be achieved via various workflows as described herein.

In one workflow, at step 3902 menu is selected. At step 3910, composing of email option is selected. At step 3918, blank editable email is selected. At step 3926, requirement is selected. At step 3934, recipients are selected. At step 3940, the email is sent. At step 3942, the analytics data is collected and analytics is done.

In another workflow, at step 3904 my database is selected. At step 3912, composing of email option is selected. At step 3920, basic email template is selected. At step 3928, requirement is selected. At step 3936, default recipients are selected and the method moves to step 3940.

In yet another workflow, at step 3906 groups is selected. At step 3914, composing of email option is selected. At step 3922, basic email template is selected. At step 3930, requirement is selected. At step 3938, default recipients are selected and the method moves to step 3940.

In still another workflow, at step 3908 requirement is selected. At step 3916, composing of email option is selected. At step 3924, basic email template is selected. At step 3932, requirement is selected. At step 3939, default recipients are selected and the method moves to step 3940.

### Update Scorecard and Personal Trend Logic:

For admin (administrator) following is score card logic—

Admin has an option to view Score card. In score card admin can view the details like requirements posted, Submissions, Interviewed and Hired status by account manager and recruiters. Here there are four columns:
1) Requirements—It shows the total requirements created by account manager or Recruiter in that particular week or Month based on the filter.
2) Submissions—It shows the total Submissions done by account manager or Recruiter from the above created requirements.
3) Interviewed—It shows the total number of candidates interviewed from the above created requirements.
4) Hired—It shows the total number of candidates hired from the above created requirements.

Requirements Logic includes—

Total Requirements—Here requirements include the total number of requirements created or posted in that particular range of date selected. (This represents the master set)
Submitted to client—It includes the total number of submissions from the above requirements.
Closed requirements—Total number of requirements closed from the above requirements.
Interviewed—It gives the number of candidates interviewed from the above requirements.
Rejected—Total number of candidates rejected from the above requirements.
Hired—Total number of candidates who accepted the offer from the above requirements.

For account manager, the score card logic includes an option called “View My Score Card”. If one clicks on this, he should able to view his individual performance. Here there are four columns:

1) Requirements—It shows the total requirements created by account manager or Recruiter in that particular week or Month based on the filter.
2) Submissions—It shows the total Submissions done by account manager or Recruiter from the above created requirements.
3) Interviewed—It shows the total number of candidates interviewed from the above created requirements
4) Hired—It shows the total number of candidates hired from the above created requirements.

Personal Trends—
1) Requirements—Here requirements include the total number of requirements created or posted in that particular range of date selected. (This represents the master set)
2) Requirement Submitted—It includes the total number of submissions from the above requirements.
3) Candidates Submitted—It includes the total number of candidates submitted from the above requirements.
4) Candidates interviewed—It gives the number of candidates interviewed from the above requirements.
5) Closed requirements—Total number of requirements closed from the above requirements.
6) Rejected—Total number of candidates rejected from the above requirements.
7) Hired—Total number of candidates who accepted the offer from the above requirements.
8) Date filter—By default it shows past 7 days from the current date.

If a candidate is hired the count increases by one in hired tab and similarly when the candidate is un-hired, the rejected count is increased and the hire count is decreased and vice versa.

Recruiter's tab (In AM)—
1) Requirements—Here requirements include the total number of requirements created or posted in that particular range of date selected. (This represents the master set)
2) Candidates Submitted—It includes the total number of candidates submitted from the above requirements.
3) Candidates interviewed—It gives the number of candidates interviewed from the above requirements.
4) Rejected—Total number of candidates rejected from the above requirements.
5) Hired—Total number of candidates who accepted the offer from the above requirements.
6) Closed requirements—Total number of requirements closed from the above requirements.
7) Date filter—By default it shows past 7 days from the current date.

For Recruiter, the Score card logic includes an option called “View My Score Card”. If one clicks on this, he views his individual performance. Here the four columns include:

1) Requirements—It shows the total requirements created by account manager or Recruiter in that particular week or Month based on the filter.
2) Submissions—It shows the total Submissions done by account manager or Recruiter from the above created requirements.
3) Interviewed—It shows the total number of candidates interviewed from the above created requirements.
4) Hired—It shows the total number of candidates hired from the above created requirements.

Personal Trends—
1) Requirements—Here requirements include the total number of requirements created or posted in that particular range of date selected. (This represents the master set)
2) Requirement Submitted—It includes the total number of submissions from the above requirements.
3) Candidates Submitted—It includes the total number of candidates submitted from the above requirements.
4) Candidates interviewed—It gives the number of candidates interviewed from the above requirements.
5) Vendors used—Total number of vendors used from the above requirements.
6) Closed requirements—Total number of requirements closed from the above requirements.
7) Rejected—Total number of candidates rejected from the above requirements.
8) Hired—Total number of candidates who accepted the offer from the above requirements.
9) Date filter—By default it shows past 7 days from the current date.

If a candidate is hired the count is increased by one in Hired tab and similarly when the candidate is rejected, the rejected count is increased and the hire count is decreased and vice versa.

For Job Seeker, the Personal Trends include—
1) Jobs Applied—Here it includes the total number of jobs applied in that particular range of date selected.
2) Shortlisted—It should include the total number of jobs shortlisted from the above applied jobs.
3) Submitted to Client—It should include the total number of submissions from the above applied jobs.
4) Interviewed—It gives the number of jobs for which the job seeker attended the interviewed from the above applied jobs.
5) Closed jobs—Total number of jobs closed from the above applied jobs. Closed jobs includes both the revoke applications and jobs closed by the recruiter. If job seeker reopens the job application, count has to be decreased from actual count.
6) Rejected—Total number of jobs rejected by recruiter and account manager from the above applied jobs.
7) Hired—Total number of jobs accepted by the job seeker from the above applied jobs.
8) Date filter—By default it shows past 7 days from the current date.

For tagging account manager functionality following process is followed. Initially Job seeker views the job details>>applies job>>notifies account manager. Job seeker searching and applying job and explicitly tagging AM. If a Job seeker already has an account manager, then by default that particular account manager is selected. He will be also having an option to select the other account manager, in spite of being selected the default account manager. If no account manager is assigned, in this case Job seeker will be having the option to choose an account manager from the list. Notifying the account manager is the final step in the process of applying the job. And it is not mandatory for Job seeker to select or notifying the account manager. If he is not interested in that point of time he can move on, and later if he wants to add he can do it from my jobs tab, where he can assign the account manager.

Once a job seeker tags or selects a particular account manager, all other account managers receive a notification in the form of feed. But the account manager who is tagged receives a notification in the form of email. If job seeker is not assigned with any organization, the popup notifying the account manager is not shown. Job seeker is able to see the information like Account Managers who tagged for that particular job in My Job section. Every account manager can view the applications of every job seeker in the Hotlist. When account manager clicks on a particular job seeker in Hotlist, he sees all the jobs applied by the job seeker and who all account managers are tagged/Assigned to them. Here there are two sections, where first section shows him the list of jobs for which he was tagged and the second section shows him the list of jobs for which other account managers tagged. Account manager has an option to change or assign other account manager for that particular candidate there itself. Admin sees the same way the account manager see the internal candidates. Admin also have an option to map other account manager if required.

In Admin there is an option where Admin can restrict the access as follows: Visible to only particular account manager option to restrict the view to the submissions done by one account manager with other or visible status to all account managers. Whenever an account manager changes, notification will be reached to all other account managers as a feed. Account manager sees all the submissions under Submissions tab with a differentiation from his submissions and the job submitted by job seeker, to track the progress and status. Dynamic Email creation for users and jobs includes following: A unique email id is generated for new job created. It is used for tracking the applicants and the context of the job. Recruiters will be posting jobs in different job boards with this unique mail id. Once the job seeker applies the job with resume, a new account will be created automatically in OnBlick application and also applied to that particular job. If there is already an account in OnBlick, the resume is updated to ask them to apply.

The job requirement can also be created by email. Ability to parse email, create profile and job includes receiving a mail along with a button to create profile or requirement. When an account manager receives a mail regarding the requirement, account manager creates that requirement from there itself by clicking on create requirement. Similarly when a recruiter receives resume from the job seeker, recruiter has an option to create profile from there itself by using the button create profile. Actions like parsing using button to create requirement and profile are done through the accounts integrated with the OnBlick mail account.

The Compliance modules ensure and recommend the organizations be compliant with US Immigration law regulations in their recruitment processes, hiring, on-boarding, placements, work authorizations, and extensions. The constant challenge in the Staffing and recruitment industry has been lack of awareness about compliance, added to this lot of documentation & time bound processes make it too complex to handle manually. So, companies are least confident of being 100% compliance in their business. OnBlick addresses this pain point through the inbuilt compliant assistor that not only assists users on best practices on performing every activity, but also keeps reminding of deadlines, required documentations, acknowledgements ensuring activities performed in system are compliant. OnBlick Compliance address the following:

i. On Boarding Compliance (I-9 Forms assistor)
ii. I-9 Remote Authorization Compliance
iii. CPT/OPT Compliance
iv. H1B Compliance
v. LCA Compliance
vi. Contract Process Compliance
vii. Employee Termination Compliance
viii. GC Process Compliance
ix. Amendment Compliance
x. In-Progress Assignment Compliance
xi. Material Change Compliance
xii. Organization Level Policies

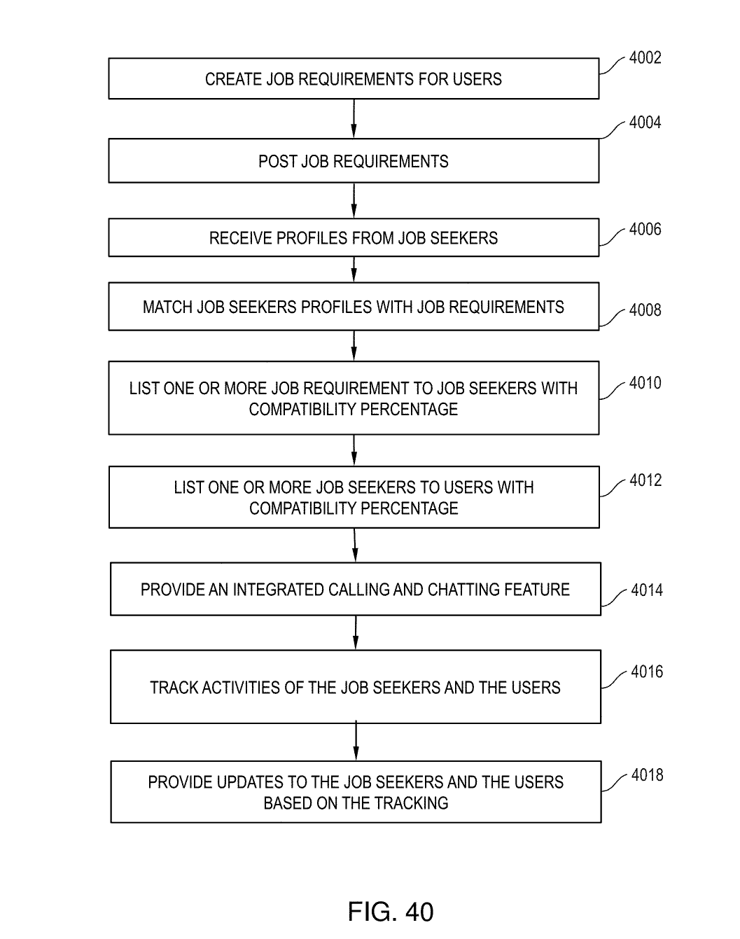

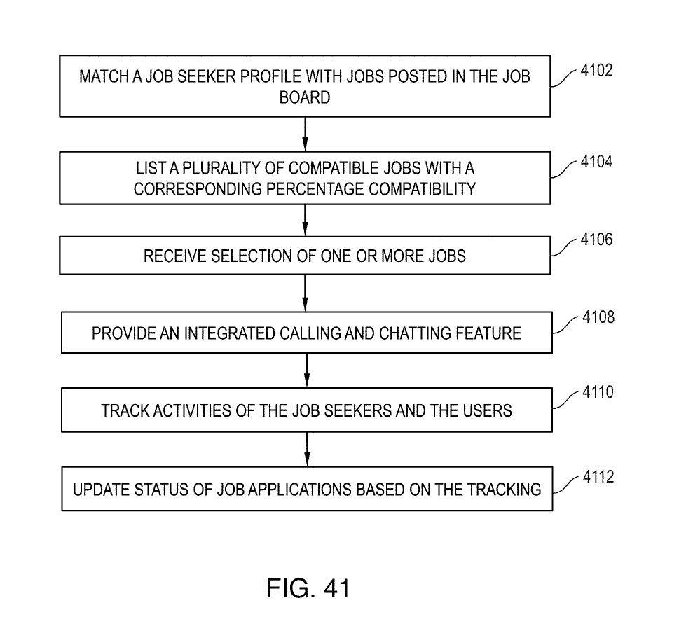

FIG. 40 is a method for job management using a job board, according to the embodiments as disclosed herein.

At step 4002, job requirements are created by users. The users include recruiters, administrators, account managers or any other person or entity interested in recruiting.

At step 4004, the job requirements are posted on the job board.

At step 4006, one or more profiles are received from job seekers.

At step 4008, the job seekers profiles are matched with job requirements.

At step 4010, one or more job requirements matching the profile of the job seeker is provided to the job seeker as a list. The list also includes compatibility percentage between the job requirement and the job seeker. The compatibility percentage is accompanied by commentary or summary indicating which skills meet between the job requirement and the job seeker and which skills lack.

At step 4012, one or more job seekers matching the job requirement are provided to a user. The list also includes compatibility percentage between the job requirement and the job seeker. The compatibility percentage is accompanied by commentary or summary indicating which skills meet between the job requirement and the job seeker and which skills lack. The parameters such as job experience, skill set etc. are configurable by the job seeker and the user. The user can give high priority to some other parameter as compared to that configured by the job seeker. Hence, the compatibility percentage between the same job and the same job seeker may be different for the user from that of the job seeker.

At step 4014, an integrated calling and chatting button or feature is provided to both the job seeker and the user to connect with each other instantly. Artificial intelligence backed up settings can be done by both the job seeker and the user to specify times for the call and locations for the call.

At step 4016, activities of the job seekers and the users are tracked.

At step 4018, updates are provided to the job seekers and the users based on the tracking. The updates may differ for the job seeker and for the user. For example, activities done by the user can be provided to the job seeker and vice versa.

The method also supports providing compliance check for the job. The method also includes determining indicators that lack in job seekers for the job, and providing to the users summary of the indicators. In addition, indicators indicative of what that job seeker lacks with respective to that job are also provided to the job seeker. In some embodiments, the update is received from within the job board, and an action related to the update is also performed from within the job board.

FIG. 41 is a method for job management by a job seeker using a job board, according to the embodiments as disclosed herein.

At step 4102, a job seekers profile is matched with job requirements, i.e. jobs posted in the job board.

At step 4104, one or more job requirements matching the profile of the job seeker is provided to the job seeker as a list. The list also includes compatibility percentage between the job requirement and the job seeker. The compatibility percentage is accompanied by commentary or summary indicating which skills meet between the job requirement and the job seeker and which skills lack.

The parameters such as job experience, skill set etc. are configurable by the job seeker and the user. The user can give high priority to some other parameter as compared to that configured by the job seeker. Hence, the compatibility percentage between the same job and the same job seeker may be different for the user from that of the job seeker.

At step 4106, selection of one or more jobs is received from the job seeker.

At step 4108, an integrated calling and chatting button or feature is provided to both the job seeker and the user to connect with each other instantly. Artificial intelligence backed up settings can be done by both the job seeker and the user to specify times for the call and locations for the call.

At step 4110, activities of the job seekers and the users are tracked.

At step 4112, updates are provided to the job seekers and the users based on the tracking. The updates may differ for the job seeker and for the user. For example, activities done by the user can be provided to the job seeker and vice versa.

The method also supports providing compliance check for the job. The method also includes determining indicators that lack in job seekers for the job, and providing to the users summary of the indicators. In addition, indicators indicative of what that job seeker lacks with respective to that job are also provided to the job seeker. In some embodiments, the update is received from within the job board, and an action related to the update is also performed from within the job board.

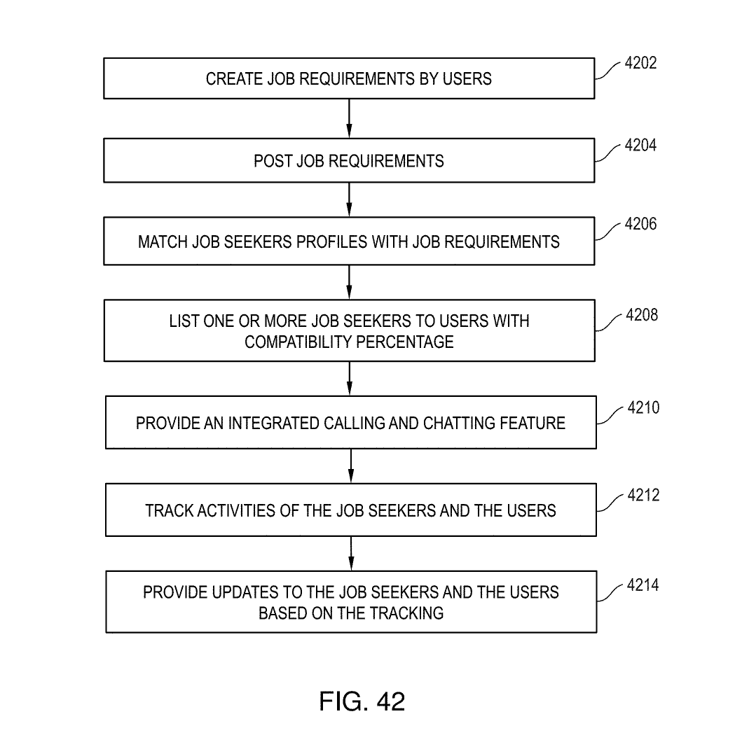

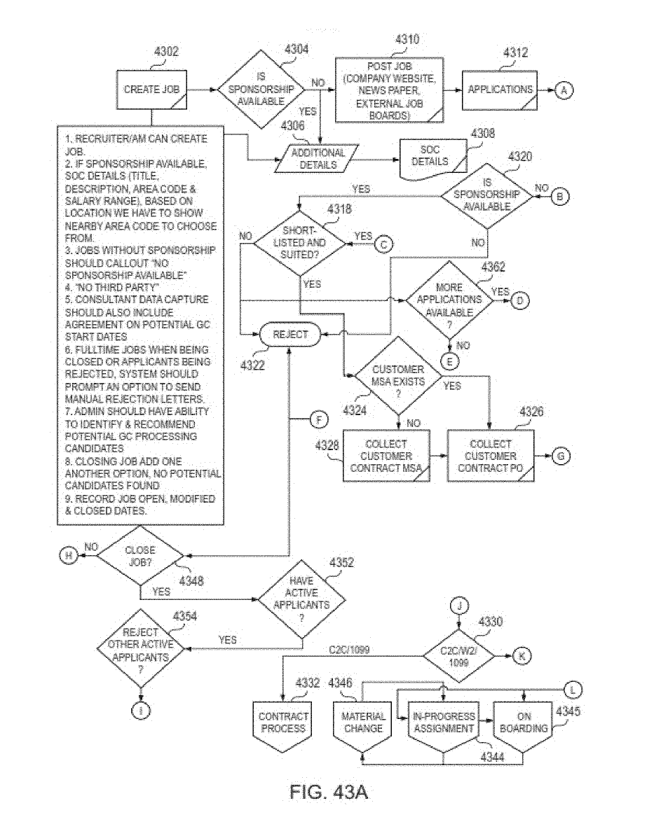

FIG. 42 is a method for job management by a user using a job board, according to the embodiments as disclosed herein.

At step 4202, job requirements are created by users. The users include recruiters, administrators, account managers or any other person or entity interested in recruiting.

At step 4204, the job requirements are posted on the job board.

At step 4206, the job seekers profiles are matched with job requirements.

At step 4208, one or more job seekers matching the job requirement are provided to a user. The list also includes compatibility percentage between the job requirement and the job seeker. The compatibility percentage is accompanied by commentary or summary indicating which skills meet between the job requirement and the job seeker and which skills lack. The parameters such as job experience, skill set etc. are configurable by the job seeker and the user. The user can give high priority to some other parameter as compared to that configured by the job seeker. Hence, the compatibility percentage between the same job and the same job seeker may be different for the user from that of the job seeker.

At step 4210, an integrated calling and chatting button or feature is provided to both the job seeker and the user to connect with each other instantly. Artificial intelligence backed up settings can be done by both the job seeker and the user to specify times for the call and locations for the call.

At step 4212, activities of the job seekers and the users are tracked.

At step 4214, updates are provided to the job seekers and the users based on the tracking. The updates may differ for the job seeker and for the user. For example, activities done by the user can be provided to the job seeker and vice versa.

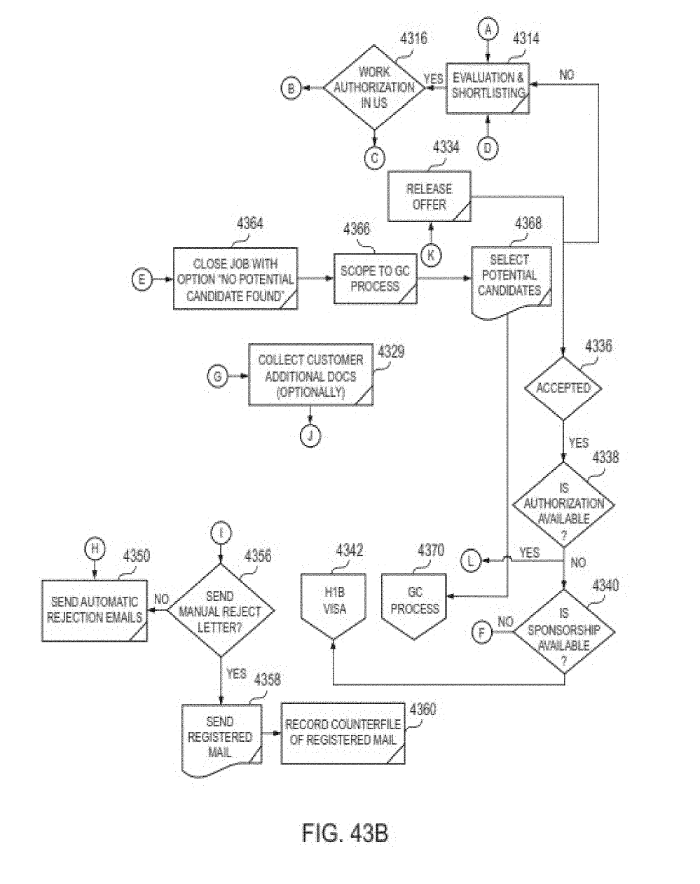

FIG. 43 (FIGS. 43A and 43B) illustrates a method for job management along with on boarding compliance, according to the embodiments as disclosed herein.

At step 4302, a job is created. At step 4304, a check is made to determine if sponsorship is available. If yes then additional details are included at step 4306 followed by SOC details at step 4308. Else, if no at step 4304 then at step 4310, job is posted. At step 4312, applications are received. At step 4314, evaluation and shortlisting is done. If shortlisted then at step 4316, a check is made to determine if work authorization in the US exists. If yes then the method moves to step 4318. If no then a check is made at step 4320 to determine if sponsorship exists. If no then the candidate is rejected at step 4322, else, at step 4318 a check is made if candidate is shortlisted and suited. If no then the candidate is rejected at step 4322, else at step 4324 a check is made if candidate's MSA exist. If yes then customer contract PO is collected at step 4326, else customer contract MSA is first collected at step 4328 followed by the step 4326.

At step 4329, additional customer documents are collected followed by a check of category at step 4330. Based on category, i.e. if C2C/1099 then contract process is initiated at step 4332. Else, if W2 then at step 4334 offer is released followed by acceptance at step 4336, followed by authorization check at step 4338, followed by sponsorship check at step 4340, followed by visa process at step 4342. If no sponsorship at step 4340 then the method moves to step 4322 for rejection. If authorization is yes at step 4338 then the method moves to in-assignment progress status at step 4344 followed by on boarding process at step 4345. In case of any material change at step 4346 triggering from step 4344 or step 4345, the method may move back to step 4344.

In some embodiments, a check is made whether to close job at step 4348. If no then automatic rejection emails are sent at step 4350. Else, if yes then, at step 4352 a check is made for active applicants. If no then stop. But if yes then at step 4354 reject other applicants via sending automatic rejection emails at step 4350 or via sending manual rejections via step 4356, step 4358, and step 4360.

In some embodiments, a check is made at step 4362 if more candidates are available. If no then close job at step 4364 followed by scope to GC process at step 4366, followed by select potential candidates at step 4368, followed by the GC process at step 4370. If more candidates are available at step 4362 then the method moves to step 4314.

The Compliance modules ensures and recommends the Organizations be compliant with US Immigration law regulations in their recruitment processes, hiring, on-boarding, placements, work authorizations, and extensions. The constant challenge in the Staffing and recruitment industry has been lack of awareness about compliance, added to this lot of documentation and time bound processes make it too complex to handle manually. So, companies are least confident of being 100% compliance in their business. OnBlick addresses this pain point through the inbuilt compliant assistor that not only assists users on best practices on performing every activity, but also keeps reminding of deadlines, required documentations, acknowledgements ensuring activities performed in system are compliant. OnBlick Compliance address the following:

i. On Boarding Compliance (I-9 Forms assistor)
ii. I-9 Remote Authorization Compliance
iii. CPT/OPT Compliance
iv. H1B Compliance
v. LCA Compliance
vi. Contract Process Compliance
vii. Employee Termination Compliance
viii. GC Process Compliance
ix. Amendment Compliance
x. In-Progress Assignment Compliance
xi. Material Change Compliance
xii. Organization Level Policies

The method also supports providing compliance check for the job. The method also includes determining indicators that lack in job seekers for the job, and providing to the users summary of the indicators. In addition, indicators indicative of what that job seeker lacks with respective to that job are also provided to the job seeker. In some embodiments, the update is received from within the job board, and an action related to the update is also performed from within the job board.

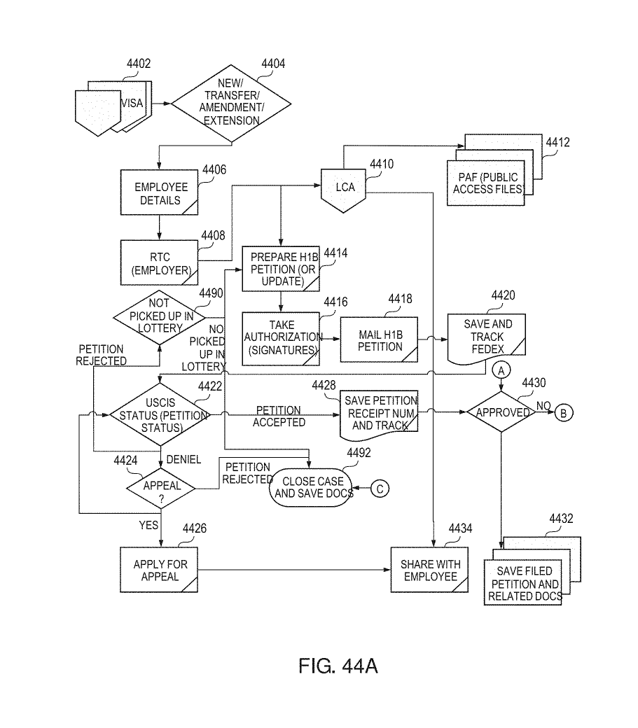

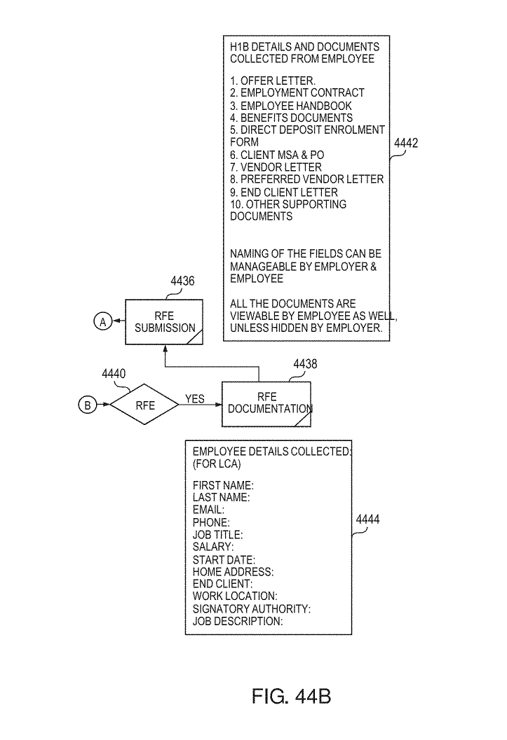

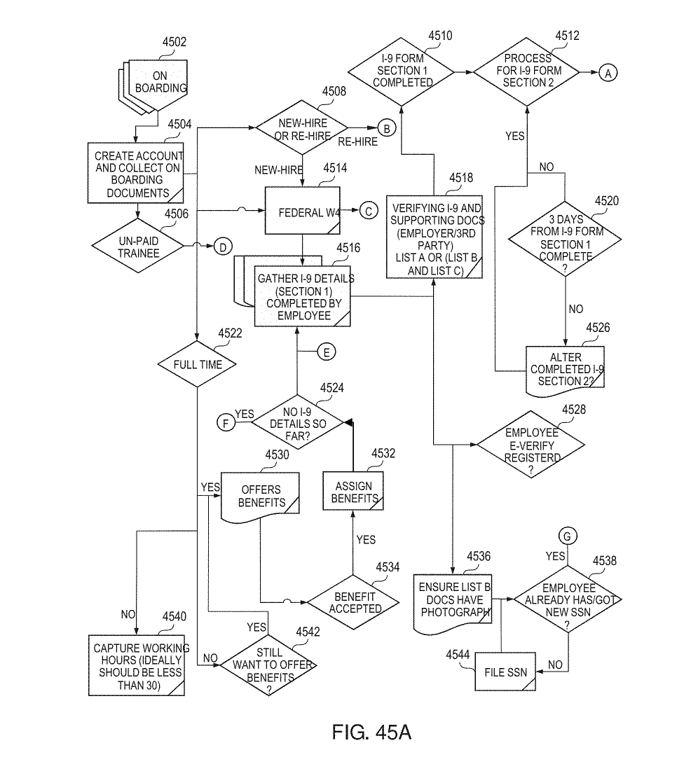

FIGS. 44 (44A and 44B) illustrates a H1B Process, according to at least some embodiments as disclosed herein. If the selected job seeker as following the above process (disclosed with reference to FIGS. 43A-43B and other figures), doesn't have work authorization and the organizations are willing to sponsor H1B, they can initiate H1B Visa to the job seekers, as shown in FIG. 44. In an example, H1B new visa process has a defined timeline (typically March every year) and limited quota. The process assists Hiring Manager not to miss any documentation for future references. Also, in the process of application, if there are any RFE (Request for Evidence), these all can be tracked from the application.

The process starts at step 4402. At step 4404, a check is made for new transfer amendment/extension followed by employee details at step 4406 followed by RTC at step 4408 followed by LCA process at step 4410 and then to public access files at step 4412. Another route after the step 4410 moves to step 4434 (share with employee).

At step 4414, H1B petition or update is prepared. At step 4416 authorization is obtained. At step 4418, H1B petition is mailed followed by saving and tracking at step 4420 followed by USCIS status at step 4422. If the petition is accepted at step 4422 then at step 4428 petition receipt number is saved and tracked followed by approval check at step 4430. If not approved then RFE is checked at step 4440. If RFE checked is yes then at step 4438 RFE documentation is done followed by RFE submission at step 4436 followed by step 4430. Else, if yes at step 4430 then save filed petition and related documents at step 4432. If RFE checked is No at step 4438 then at step 4492 close case and save documents.

If at step 4422 petition is denied then at step 4424 a check for appeal is done. If outcome is yes at step 4424 then appeal is applied at step 4426 followed by sharing with employee at step 4434. Else, if petition is rejected at step 4424 then close case and save documents at step 4492. Else, if appeal check is No at step 4424 then the method moves to step 4422. If at step 4422 the petition is rejected then method moves to a check for not picked up in lottery at step 4490. If not picked then close case and save documents at step 4492 else move to step 4414.

Step 4442 shows detail on H1B and documents collected from employee.

Step 4444 shows collected employee details for LCA (labour condition application).

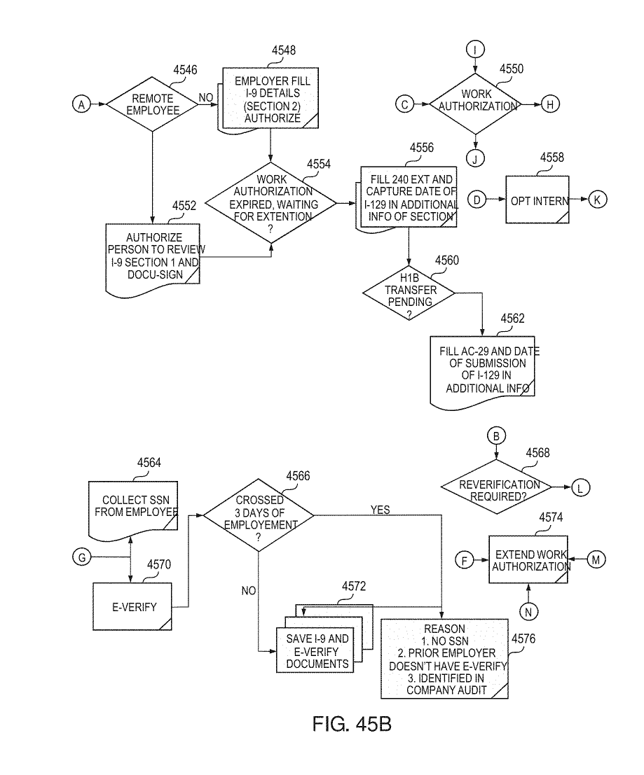

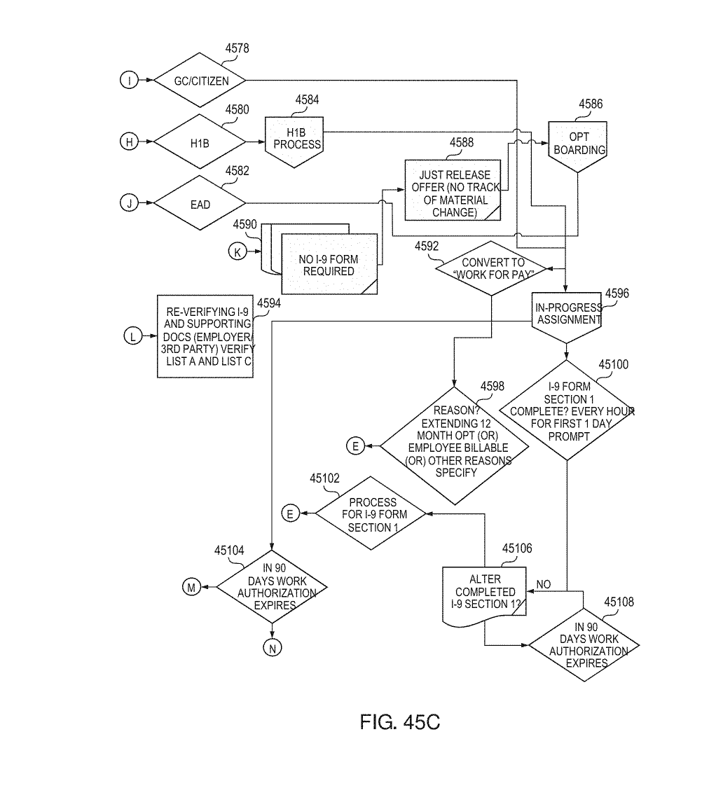

FIG. 45 (FIG. 45A, FIG. 45B and FIG. 45C) illustrates OnBoarding process. Once job seeker has been hired, then OnBoarding process starts. Organization hiring manager will create an account to that selected candidate, start initiating documentation process that involves filing I-9. Where in I-9 Section 1, will be asked to be filled by Job seeker, and section 2 of the same I-9 form will be filled by Employer or authorized representative of the employer. These forms should be filled with in the specified timelines (Section 1 should be filled with in a day of starting work, and Section 2 should be filled with in 3 days of completion of Section 1). OnBoarding process also involves offering Benefits to the employees as per the Organization policies. Here, as to be compliance, Organization should assign benefits to all or none. E-Verify is another process that if Organizations E-Verify subscribed company, they will have to ensure that is adhered and taken care within 3 days of Employment. In this process, every document is collected and maintained for future records.

The method starts at step 4502 followed by account creation at step 4504. A check is made for unpaid trainee at step 4506 followed by opt intern at step 4558 followed by no I-9 form required at step 4590. At step 4588 the offer is released followed by opt boarding at step 4586 and EAD at step 4582.

At step 4508, a check is made for new hire or re-hire. If new hire then federal W4 is done at step 4514 followed by I-9 process shown in step 4516, 4518, 4510 4512, 4546, 4548, and 4552. At step 4554, a check is done for work authorization expired or waiting for extension. At step 4556, 240 extension is filled and I-29 details are captured. At step 4560 H1B transfer pending status is checked followed by filling of AC-29.

In some embodiments, step 4514 is followed by work authorization at step 4550 followed by H1B process via steps 4580 and 4584, followed by in-progress assignment at step 4596 followed by I-9 processing at steps 45100 45108, 45106, 45102, and step 4516.

If re-hire at step 4508 then reverification requirement is checked at step 4568 with reverification at step 4594.

At step 4522 full time employment is checked. If no then either step 4540 is performed or step 4542 followed by step 4530. If yes at step 4522 then benefits process is performed at steps 4530, 4534, 4532, 4524, and 4516.

In some embodiments, employee process includes performing steps 4536, 4544, 4538, 4564, 4570, 4566, 4572, and 4576.

In some embodiments, employee e-verify registered check is done at step 4528.

In some embodiments, a loop of steps 4520, 4526, and 4512 is performed for I-9 processing.

At step 4574 work authorization is extended which follows from step 45104.

In one embodiment, step 4550 of work authorization is followed by green card process at step 4578 and the method then moves to step 4596. In another embodiment, step 4550 is followed by step EAD process at step 4582 and then step 4586.

In some embodiments, the method includes conversion to work for pay at step 4592, followed by extension at step 4598 followed by step 4516.

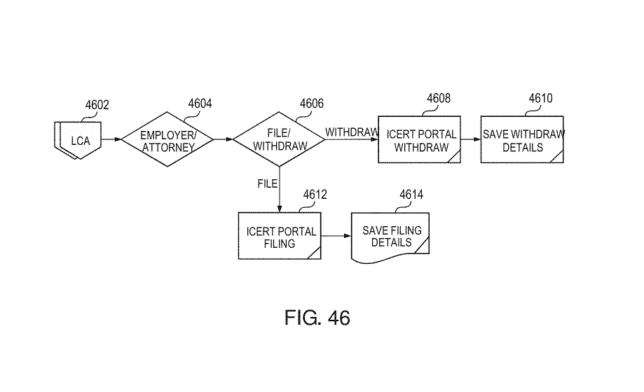

FIG. 46 illustrates LCA (Labor condition application) process. LCA filing has to be done for every H1B visa applicant and also should be refiled and renewed whenever there is a Material change for the Job Seeker while on assigned Job. Following are the cases which is considered as Material change:

1. Title/Designation changes

2. Changes in Pay Range

3. Change in Location

While actual filing of LCA will be done in iCERT portal (a US Govt portal) the details of application, status all maintained in the system.

The method starts at step 4602 and moves to employer/attorney at step 4604 followed by file/withdraw check at step 4606. If withdraw then at step 4608 ICERT portal withdraw followed by save withdraw details at step 4610 else ICERT portal filing at step 4612 followed by save filing details at step 4614.

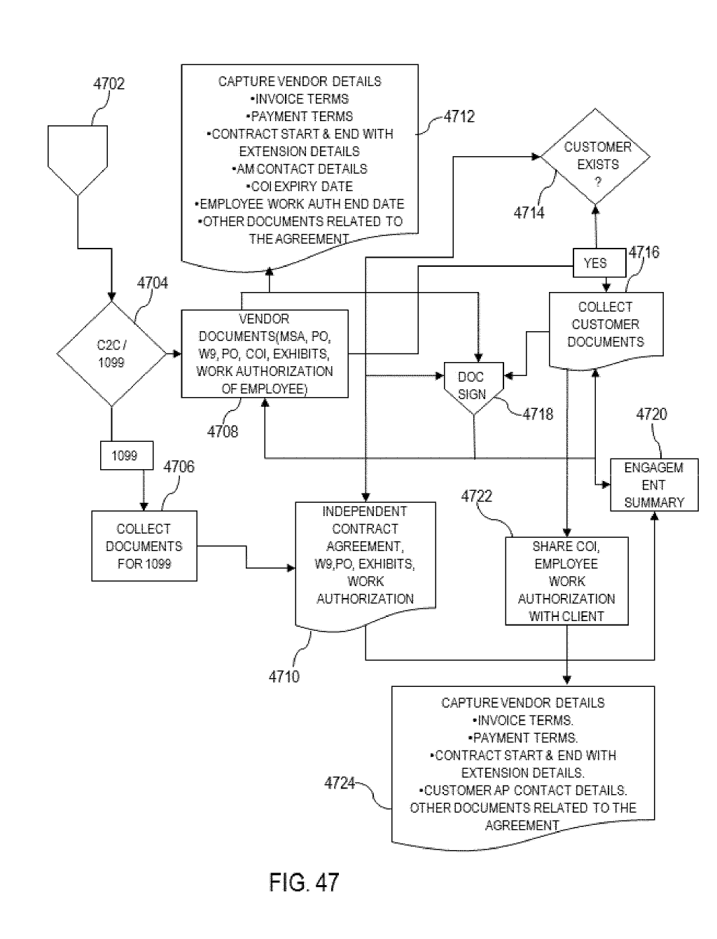

FIG. 47 illustrates contracting process. When a Job Seeker has been selected for work assignment through contracting process, there will be multiple parties involved in this agreement. The Vendor AND/OR Client documents need to be captured and maintained with all legal agreements. All such agreement documents are digitally signed and tracked for Auditing.

The method starts at step 4702 followed by a check for C2C/1099 at step 4704. If 1099 then collect documents at step 4706 followed by collection of other documents at step 4710 followed by engagement summary at step 4720. If C2C then collect vendor documents at step 4708 along with vendor details at step 4712 followed by customer documents at step 4716. The document signatures are done at step 4718. In some embodiments, a check is done if customer exists at step 4714.

The work authorization and other details are shared at step 4722 followed by vendor details capture at step 4724.

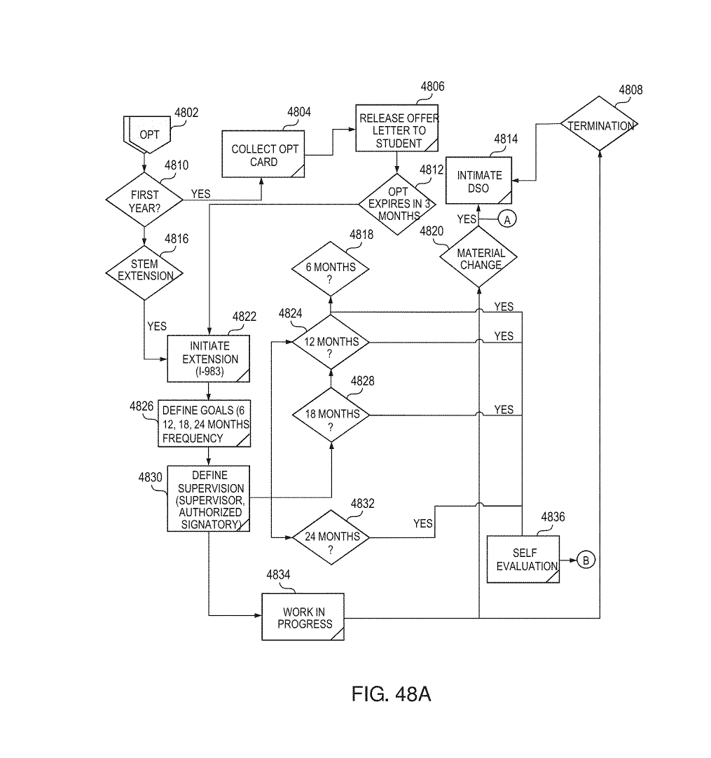

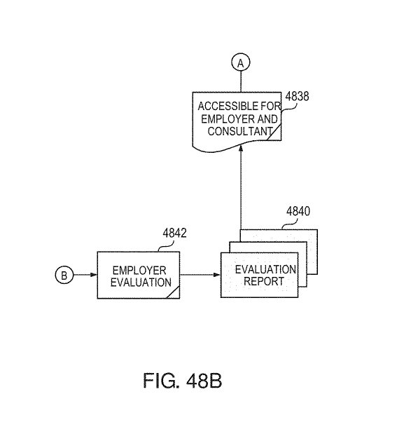

FIG. 48 (FIG. 48A and FIG. 48B) illustrates OPT (Optional Practical Training) and CPT (Curricular Practical Training) process for job seekers. This category of Job Seekers is on the student visa and has work authorizations basing on the description of the University. While these category job seekers are going to be engaged in work, Organizations should follow certain process depicted in this picture represented in FIG. 48. Every such Job seeker will have mentor and have the periodic evaluation. OnBlick system will keep reminding the Admin & Hiring Manager about the evaluations & status of the OPT/CPT work permits.

The method starts at step 4802. If first year at step 4810 then collect OPT card at step 4804 followed by offer release at step 4806 followed by OPT expiration at step 4812 followed by extension initiation at step 4822. If not first year then stem extension check at step 4816 followed by initiate extension at step 4822 followed by goal defining at step 4826 followed by supervision defining at step 4830. In one embodiment, supervision defining, at step 4830, is done for multiple months at steps 4828, 4832, 4824, and 4818, which is followed by self evaluation at step 4836 followed by employer evaluation at step 4842 followed by evaluation report at step 4840 followed by providing access to report at step 4838 and finally by DSO intimation at step 4814. In another embodiment, supervision defining at step 4830 is followed by work in progress at step 4834 followed by termination at step 4808 and then DSO intimation as step 4814. In some embodiments, the work in progress at step 4834 is followed by material change at step 4820 followed by DSO intimation at step 4814.

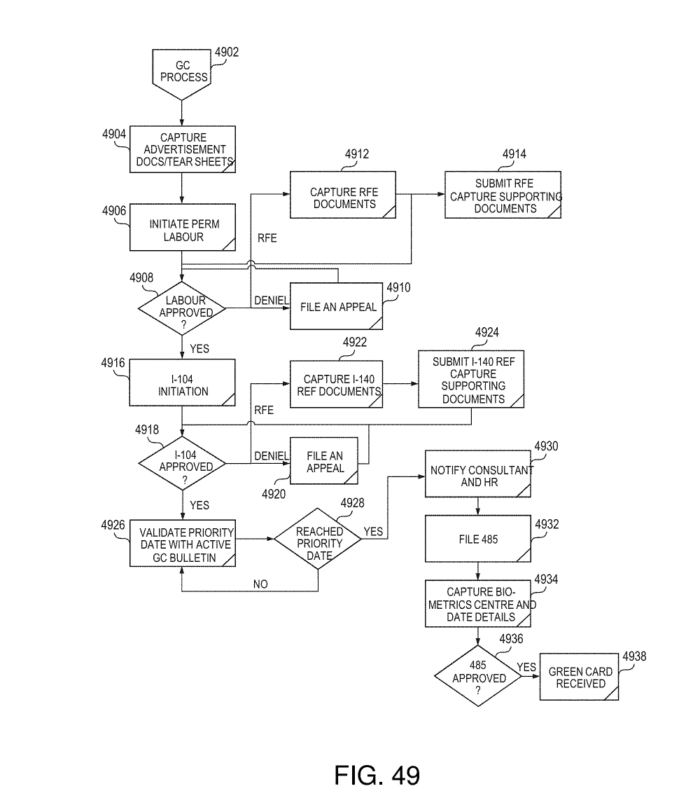

FIG. 49 depicts illustrate the process for the GC (Green Card) or PERM. PERM is the process for obtaining labor certification, the first step of the green card process for foreign nationals seeking permanent residence through their employment. The U.S. employer requests a permanent labor certification by completing an Application for Permanent Employment Certification (“ETA Form 9089”). The following are the overall high level steps in the green card process.
1. Immigrant Petition: Either an employer, relative or in some cases the applicant files an immigration petition for the beneficiary. e.g., I-140 is filed for employment based immigration while I-130 is filed for family based immigration.
2. Immigrant Visa Availability: As there are quotas and restrictions in most categories of green card, a person is not immediately able to get the green card after the immigrant petition is completed. After the immigrant petition is approved, the case is transferred to the
3. Adjudication: Once the Immigration Visa Number is available, that is the Priority date is current, the person can adjust their status to permanent resident is he/she is already in the US or if the person is outside of the US he/she can apply for the immigrant visa at the US embassy/consulate that has the Jurisdiction over his/her residence.

The method starts at step 4902 followed by capture of advertisement/documents/tear sheets at step 4904. Labour PERM is initiated at step 4906. A check for labour approval is performed at step 4908. If approved then I-104 initiation is done at step 4916 followed by a check for I-104 approval at step 4918. If approved then validate priority date with active GC bulletin at step 4926 followed by a check on reaching priority date at step 4928. If no then move to step 4926 else notify consultant and HR at step 4930 followed by filing of 485 at step 4932 followed by biometrics capture at step 4934 followed by 485 approval at step 4936 and Green card receipt at step 4938.

If I-104 initiation is denied then file an appeal at step 4920 followed by step 4918. If RFE at step 4918 then capture I-140 ref documents at step 4922 followed by submission of I-140 ref at step 4924 followed by step 4918.

If labour denied at step 4908 the file an appeal at step 4910. If RFE at step 4908 the capture RFE documents at step 4912 followed by submission at step 4914 and step 4908.

Various embodiments provide various benefits. For example, every activity performed with in OnBlick is captured as data point for future analytics. For example, in the recruitment process, typically an activity is started from the point of creation of job, then posting to different job boards, then viewing besting matching job seekers, then interacting with the potential job seekers, short listing, submitting to client, scheduling interview and finally hiring the job seekers. In this process system automatically captures every activity performed by the recruiter, account manager and job seekers with respect to a particular Job. Analytics built on top of this data can give insights that will help management clear view of process progress and where things are going wrong v/s good, and assist companies to fine tune their process and take proper decisions for the growth of the company. Various embodiments provided herein assist the recruiter guiding with soc code details and suggestions of applied wages while creating jobs, and assists the recruiters to do proper due diligence in recruitment process while hiring or rejecting. Furthermore, embodiments provide admin information on missing versus need immediate attention.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method for providing a job board for automated job management, the method comprising:
creating job requirements for users, wherein a user comprises at least one of: a recruiter of a company, an account manager, and an administrator;
posting the job requirements;
receiving profiles from job seekers;
matching the profiles with the job requirements;
listing one or more job requirements to the job seekers with corresponding percentage compatibility, wherein the percentage compatibility is generated based on a plurality of parameters;
listing one or more job seekers to the users with the corresponding percentage compatibility, wherein the percentage compatibility is generated based on the plurality of parameters;
providing an integrated calling and chatting feature in the job board thereby allowing the job seekers and the users to connect instantly;
tracking activities of the job seekers and the users; and
providing updates to the job seekers and the users, based on the tracking.

2. The method as claimed in claim 1 further comprising facilitating the job seekers to record their video profiles of a pre-determined duration.

3. The method as claimed in claim 1, wherein providing the integrated calling and chatting feature comprises providing relevance of each of calls or chats provided in the job board.

4. The method as claimed in claim 1 and further comprising:
providing compliance checking to the users

5. The method as claimed in claim 1 and further comprising:
assisting the recruiter guiding with soc code details and suggestions of applied wages while creating jobs;
assisting the recruiter to do proper due diligence in recruitment process while hiring or rejecting; and
providing admin information on missing versus need immediate attention.

6. The method as claimed in claim 1 and further comprising:
enabling the job seekers to set their preferred times or locations for different days for interaction with the users.

7. The method as claimed in claim 1 and further comprising:
determining indicators that lack in job seekers for the job; and
providing to the users summary of the indicators.

8. The method as claimed in claim 7 and further comprising:
providing to the job seekers the indicators indicative of what that the job seekers lack with respective to that job.

9. The method as claimed in claim 1 and further comprising:
receiving update on job requirement from within the job board; and
performing an action related to the update from within the job board.

10. The method as claimed in claim 1 and further comprising:
providing options to the users and the job seekers to configure the plurality of parameters.

11. The method as claimed in claim 10, wherein the percentage compatibility between a job seeker and a job differ for the users from that shown to the job seeker based on the configuration.

12. A method to provide an integrated job board for job management by job seekers, the method comprising:
matching a job seeker profile with jobs posted in the job board;
listing a plurality of compatible jobs with corresponding percentage compatibility, wherein the percentage compatibility is generated based on a plurality of parameters;
receiving selection of one or more jobs by the job seeker;
providing an integrated calling and chatting feature to allow the job seeker to instantly connect with users of the one or more jobs;
tracking activities of the job seeker and the users; and
updating status of the one or more job applications based on the tracked activities.

13. The method as claimed in claim 12 and further comprising:
enabling the job seeker to set preferred times or locations for different days for interaction with the users.

14. The method as claimed in claim 12 and further comprising:
providing to the job seeker indicators indicative of what that job seeker lacks with respective to that job.

15. The method as claimed in claim 12 and further comprising:
receiving update on job requirement from within the job board; and
performing an action related to the update from within the job board.

16. The method as claimed in claim 12 and further comprising:
providing options to the job seeker to configure the plurality of parameters.

17. The method as claimed in claim 16, wherein the percentage compatibility between the job seeker and the job differ for a user from that shown to the job seeker based on the configuration.

18. A method to provide an integrated job board for job management by users, the method comprising:
creating job requirements for the users, wherein a user comprises at least one of: a recruiter of a company, an account manager, and an administrator;
posting the job requirements;
matching job seekers profiles with the job requirements;
listing one or more job seekers to the users with the corresponding percentage compatibility, wherein the percentage compatibility is generated based on the plurality of parameters;
providing an integrated calling and chatting feature in the job board thereby allowing the job seekers and the users to connect instantly;
tracking activities of the job seekers and the users; and
providing updates to users, based on the tracking.

19. The method as claimed in claim 18 and further comprising:
providing compliance checking to the users.

20. The method as claimed in claim 18 and further comprising:
determining indicators that lack in job seekers for the job; and
providing to the users summary of the indicators.

21. The method as claimed in claim 18 and further comprising:
receiving update on job requirement from within the job board; and
performing an action related to the update from within the job board.

22. The method as claimed in claim 18 and further comprising:
providing options to the users to configure the plurality of parameters.

23. The method as claimed in claim 22, wherein the percentage compatibility between a job seeker and a job may differ for the users from that shown to the job seeker based on the configuration.
